(19) United States
(12) Patent Application Publication
(10) Pub. No.: US 2016/0087389 A1
(43) Pub. Date: Mar. 24, 2016

(54) LASER SYSTEM, EXTREME ULTRAVIOLET LIGHT GENERATION SYSTEM, AND METHOD OF CONTROLLING LASER APPARATUS

(71) Applicant: GIGAPHOTON INC., Tochigi (JP)

(72) Inventors: Motoki NIWANO, Oyama (JP); Takashi SAITO, Oyama (JP)

(73) Assignee: GIGAPHOTON INC., Tochigi (JP)

(21) Appl. No.: 14/960,579

(22) Filed: Dec. 7, 2015

Related U.S. Application Data
(63) Continuation of application No. PCT/JP2014/068163, filed on Jul. 8, 2014.

(30) Foreign Application Priority Data
Jul. 25, 2013 (JP) 2013-154365

(51) Int. Cl. H01S 3/00; G02F 1/03; H01S 3/13; H01S 3/23; H05G 2/00; H01S 3/10

(52) U.S. Cl. CPC H01S 3/0085; H05G 2/008; H05G 2/003; H01S 3/10015; H01S 3/1301; H01S 3/2316; G02F 1/03; H01S 3/0064

(57) ABSTRACT

A laser system capable of appropriately controlling the energy of a laser beam pulse is provided. An exemplary laser system of the present disclosure may control an optical isolator to switch from a closed state to an open state and then to return to the closed state for each of the laser beam pulses repeatedly outputted from a master oscillator. The laser system may control the optical attenuator to set an optical transmittance of the optical attenuator for each of the laser beam pulses repeatedly outputted from the master oscillator.

### CROSS-REFERENCE TO A RELATED APPLICATION

The present application claims priority from Japanese patent application No. 2013-154365 filed on Jul. 25, 2013, the content of which is hereby incorporated by reference into this application.

### BACKGROUND

1. Technical Field

This disclosure relates to a laser system, an extreme ultraviolet light generation system, and a method of controlling a laser apparatus.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 70 nm to 45 nm, and further, microfabrication with feature sizes of 32 nm or less will be required. In order to meet the demand for microfabrication with feature sizes of 32 nm or less, for example, an exposure apparatus is needed in which a system for generating extreme ultraviolet (EUV) light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### CITATION LIST

### Patent Literature

PTL 1: Japanese Patent No. 3775840
PTL 2: Japanese Patent Application Publication No. 2010-514214
PTL 3: Japanese Patent Application Publication No. 2010-519783
PTL 4: Japanese Patent Application Publication No. 2012-216769
PTL 5: Japanese Patent Application Publication No. 2012-216768
PTL 6: Japanese Patent Application Publication No. 2011-210704

### SUMMARY

An example of laser system according to the present disclosure may include a master oscillator configured to output laser beam pulses, multiple stages of optical amplifiers disposed on an optical path of the laser beam pulses outputted from the master oscillator and configured to sequentially amplify the laser beam pulses, an optical isolator disposed on the optical path and capable of switching between an open state and a closed state, an optical attenuator disposed on the optical path and capable of setting an optical transmittance, and a controller configured to control the optical isolator and the optical attenuator. The controller may control the optical isolator to switch from the closed state to the open state and then to return to the closed state for each of the laser beam pulses repeatedly outputted from the master oscillator. The controller may control the optical attenuator to set an optical transmittance of the optical attenuator for each of the laser beam pulses repeatedly outputted from the master oscillator.

### BRIEF DESCRIPTION OF THE DRAWINGS

Hereinafter, selected embodiments of the present disclosure will be described with reference to the accompanying drawings.

FIG. 1 schematically illustrates an exemplary configuration of an LPP type EUV light generation system.

FIG. 2 is a partial cross-sectional view illustrating the configuration of an EUV light generation system.

FIG. 3 is a block diagram illustrating control of a target supply device and a laser apparatus performed by an EUV light generation controller.

FIG. 4 schematically illustrates a comparative example of the configuration of a laser system including a laser apparatus and a laser controller.

FIG. 5A is a timing chart of a bust signal.

FIG. 5B is a timing chart of a passage timing signal.

FIG. 5C is a timing chart of a light emission trigger signal.

FIG. 5D is a timing chart of a master oscillator output.

FIG. 5E is a timing chart of a pulse laser beam.

FIG. 5F is a timing chart of EUV light.

FIG. 6A shows an example of measured pulse energy of burst laser beam pulses.

FIG. 6B shows an example of measured pulse energy of burst EUV light pulses.

FIG. 7 schematically illustrates a configuration example of an optical isolator.

FIG. 8 schematically illustrates a configuration example of a laser system including a laser apparatus including a variable attenuator and a laser controller.

FIG. 9 schematically illustrates a configuration and operation of a variable attenuator.

FIG. 10 schematically illustrates operation timing of optical isolators.

FIG. 11A is a timing chart of a light emission trigger signal.

FIG. 11B is a timing chart of a master oscillator pulse laser beam.

FIG. 11C is a timing chart of a bust signal.

FIG. 11D is a timing chart of a control voltage for an optical isolator.

FIG. 11E is a timing chart of a control voltage for an attenuator.

FIG. 11F is a timing chart of an applied pulse laser beam.

FIG. 11G is a timing chart of EUV light.

FIG. 12 schematically illustrates temporal variation of pulse energy of burst EUV light pulses.

FIG. 13 is an example of a flowchart of controlling applied voltage in the variable attenuator.

FIG. 14 illustrates a configuration example of a spike control data table.

FIG. 15A illustrates an example of measured applied voltages in the variable attenuator in spike control.

FIG. 15B illustrates an example of measured EUV light pulse energy in spike control.

FIG. 16 is an example of a flowchart of spike control S114 in the flowchart of FIG. 13.

FIG. 17 is an example of a flowchart of updating a spike control data table S116 in the flowchart of FIG. 13.

FIG. 18 is an example of a flowchart of feedback control S117 in the flowchart of FIG. 13.

FIG. 19 is an example of a flowchart of storing feedback control data S119 in the flowchart of FIG. 13.

FIG. 20 is an example of a flowchart of controlling applied voltage in the variable attenuator.

FIG. 21 is an example of a flowchart of Step S202 in the flowchart of FIG. 20.

### DETAILED DESCRIPTION

### Contents

### 1. Overview

### 2. Terms

### 3. Overview of EUV Light Generation System

3.1 Configuration

3.2 Operation

### 4. Control of Target Supply Device and Laser Apparatus in EUV Light Generation System

4.1 Configuration of EUV Light Generation System

4.2 Operation

### 5. Comparative Example of Configuration of Laser System Including Laser Apparatus and Laser Controller

5.1 Configuration

5.2 Operation

5.3 Issues
5.3.1 Stabilizing EUV Light Pulse Energy
5.3.2 Configuration of Optical Isolator
5.3.3 Issue on Control of Laser Beam Pulses by Optical Isolator
   6. Laser System Including Laser Apparatus including Variable Attenuator and Laser Controller

6.1 Configuration

6.2 Operation

6.3 Effect

6.4 Others

### 7. Method of Controlling Applied Voltage in Variable Attenuator

7.1 First Control Method

7.2 Second Control Method

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

### 1. OVERVIEW

An LPP type EUV light generation system can produce EUV light by irradiating a target with a laser beam outputted from a laser apparatus to change the target into plasma. The LPP type EUV light generation system for an exposure apparatus can be required to generate EUV light pulses at a high cyclic frequency of 50 to 100 kHz or higher and to control the pulse energy of the EUV light pulses one by one. To control the pulse energy of the EUV light pulses one by one, it can be required to control the pulse energy of the laser beam outputted from the laser apparatus pulse by pulse.

However, it is difficult to control the pulse energy of a laser beam in the high cyclic frequency of 50 to 100 kHz or higher. For not only the EUV light generation system but other apparatuses such as laser processing machines, it is difficult to control the pulse energy of a laser beam pulse by pulse.

According to one aspect of the present disclosure, the laser system may control an optical isolator to switch from a closed state into an open state and then to return to the closed state for each laser beam pulse repeatedly outputted from the master oscillator. Furthermore, the laser system may control an optical attenuator to set a transmittance to the optical attenuator for each laser beam pulse repeatedly outputted from the master oscillator.

According to one aspect of the present disclosure, the pulse energy of a laser beam can be appropriately controlled pulse by pulse while preventing the operational stability of the laser apparatus from being impaired.

### 2. TERMS

Terms used in the present application will be described hereinafter. A “plasma generation region” may refer to a region where the generation of plasma for generating EUV light begins. It may be necessary for a target to be supplied to the plasma generation region and for a pulse laser beam to be focused at the plasma generation region at the timing at which the target reaches the plasma generation region in order for the generation of plasma to begin at the plasma generation region.

“Burst laser beam pulses” may be a series of laser beam pulses. “Burst EUV light pulses” may be a series of EUV light pulses. A “light emission trigger signal” may be a signal that contains a light emission trigger pulse. A “burst period” may be a period in which a burst signal is ON.

### 3. OVERVIEW OF EUV LIGHT GENERATION SYSTEM

### 3.1 Configuration

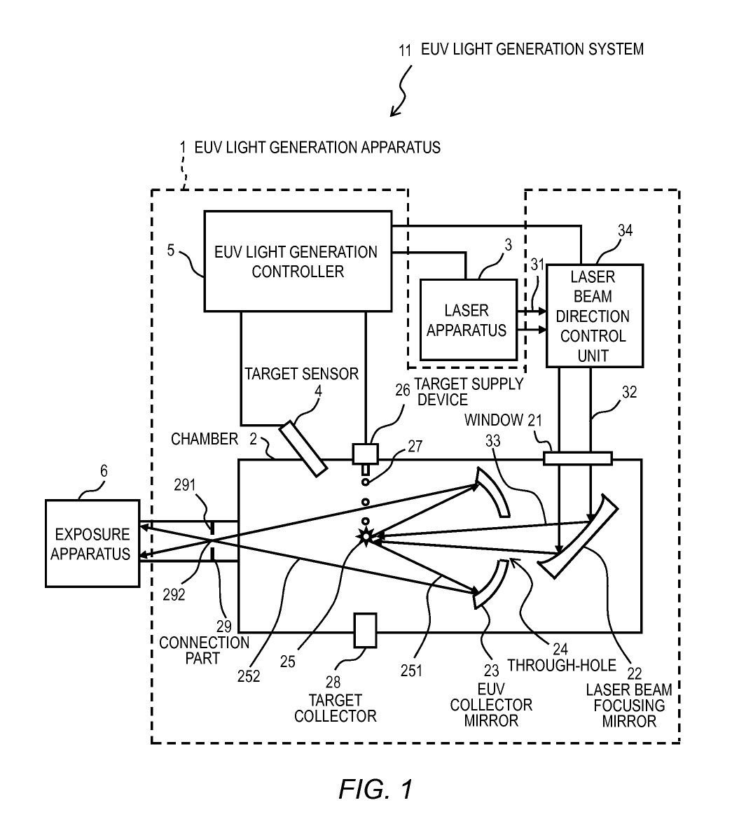

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation apparatus 1 may include a chamber 2 and a target supply device 26.

The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole formed in its wall, a window 21 may be installed in the through-hole, and the pulse laser beam 32 from the laser apparatus 3 may travel through the window 21. An EUV collector mirror 23 having a spheroidal surface may, for example, be provided in the chamber 2. The EUV collector mirror 23 may have a first focus and a second focus.

The EUV collector mirror 23 may have a multi-layered reflective film including alternately laminated molybdenum layers and silicon layers formed on the surface thereof. The EUV collector mirror 23 is preferably positioned such that the first focus lies in a plasma generation region 25 and the second focus lies in an intermediate focus (IF) region 292. The EUV collector mirror 23 may have a through-hole 24 formed at the center thereof and a pulse laser beam 33 may travel through the through-hole 24.

The EUV light generation apparatus 1 may include an EUV light generation controller 5 and a target sensor 4. The target sensor 4 may have an imaging function and detect at least one of the presence, trajectory, position, and speed of a target 27.

Further, the EUV light generation apparatus 1 may include a connection part 29 for allowing the interior of the chamber 2 to be in communication with the interior of the exposure apparatus 6. A wall 291 having an aperture may be provided in the connection part 29. The wall 291 may be positioned such that the second focus of the EUV collector mirror 23 lies in the aperture.

The EUV light generation apparatus 1 may also include a laser beam direction control unit 34, a laser beam focusing mirror 22, and a target collector 28 for collecting targets 27. The laser beam direction control unit 34 may include an optical element for defining the direction and an actuator for adjusting the position, the orientation or posture, and the like of the optical element.

### 3.2 Operation

With reference to FIG. 1, a pulse laser beam 31 outputted from the laser apparatus 3 may pass through the laser beam direction control unit 34 and, as the pulse laser beam 32, travel through the window 21 and enter the chamber 2. The pulse laser beam 32 may travel inside the chamber 2 along at least one beam path, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam, the target 27 may be turned into plasma, and rays of light 251 may be emitted from the plasma.

The EUV light 252 included in the light 251 may be reflected selectively by the EUV collector mirror 23. EUV light 252 reflected by the EUV collector mirror 23 may be focused at the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control: the timing when the target 27 is outputted and the direction into which the target 27 is outputted, for example.

Furthermore, the EUV light generation controller 5 may be configured to control at least one of: the timing when the laser apparatus 3 oscillates, the direction in which the pulse laser beam 33 travels, and the position at which the pulse laser beam 33 is focused. It will be appreciated that the various controls mentioned above are merely examples, and other controls may be added as necessary.

### 4. CONTROL OF TARGET SUPPLY DEVICE AND LASER APPARATUS IN EUV LIGHT GENERATION SYSTEM

### 4.1 Configuration of EUV Light Generation System

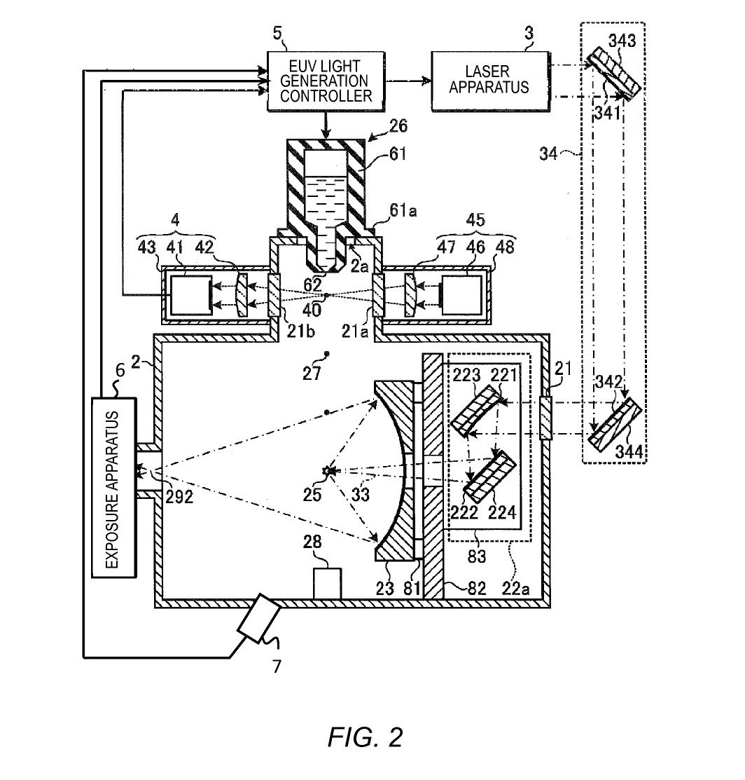

FIG. 2 is a partial cross-sectional view illustrating a configuration example of the EUV light generation system 11. As shown in FIG. 2, a laser beam focusing optical system 22a, the EUV collector mirror 23, the target collector 28, an EUV collector mirror holder 81, and plates 82 and 83 may be provided within the chamber 2.

The plate 82 may be anchored to the chamber 2. The plate 83 may be anchored to the plate 82. The EUV collector mirror 23 may be anchored to the plate 82 via the EUV collector mirror holder 81.

The laser beam focusing optical system 22a may include an off-axis paraboloid mirror 221, a flat mirror 222, and holders 223 and 224. The off-axis paraboloid mirror 221 and the flat mirror 222 may be held by the holders 223 and 224, respectively. The holders 223 and 224 may be anchored to the plate 83.

The positions and orientations of the off-axis paraboloid mirror 221 and the flat mirror 222 may be held so that the pulse laser beam 33 reflected by those mirrors is focused at the plasma generation region 25. The target collector 28 may be disposed upon a straight line extending from the trajectory of the target 27.

The target supply device 26 may be attached to the chamber 2. The target supply device 26 may include a reservoir 61. The reservoir 61 may hold a target material that has been melted using a heater 261 shown in FIG. 3. An opening serving as a nozzle opening 62 may be formed in the reservoir 61.

Part of the reservoir 61 may be inserted into a through-hole 2a formed in a wall surface of the chamber 2 so that the nozzle opening 62 formed in the reservoir 61 is positioned inside the chamber 2. The target supply device 26 may supply the melted target material to the plasma generation region 25 within the chamber 2 as droplet-shaped targets 27 via the nozzle opening 62. A flange portion 61a of the reservoir 61 may be tightly fitted and anchored to the wall surface of the chamber 2 in the periphery of the through-hole 2a.

The target sensor 4 and a light-emitting section 45 may be attached to the chamber 2. The target sensor 4 may include a photodetector 41, an image forming optical system 42, and a receptacle 43. The light-emitting section 45 may include a light source 46, a focusing optical system 47, and a receptacle 48. Light outputted from the light source 46 can be focused by the focusing optical system 47. The focal position of the outputted light may be located substantially upon the trajectory of the targets 27.

The target sensor 4 and the light-emitting section 45 may be disposed opposite to each other on either side of the trajectory of the targets 27. Windows 21a and 21b may be provided in the chamber 2. The window 21a may be positioned between the light-emitting section 45 and the trajectory of the targets 27.

The light-emitting section 45 may focus light at a predetermined position in the trajectory of the targets 27 via the window 21a. When the target 27 passes through the focal position of the light emitted from the light-emitting section 45, the target sensor 4 may detect a change in the light passing through the trajectory of the target 27 and the vicinity thereof. The image forming optical system 42 may form, upon a light-receiving surface of the target sensor 4, an image of the trajectory of the target 27 and the vicinity thereof, in order to improve the accuracy of the detection of the target 27.

A position of the center of the target 27 detected by the target sensor 4 will be referred to as a target detection position 40 in the following descriptions. In the example shown in FIG. 2, the target detection position 40 can substantially match the focal position of the light emitted from the light-emitting section 45.

An EUV light pulse energy sensor 7 may be attached on the chamber 2. The EUV light pulse energy sensor 7 may be provided at a place where the energy of the EUV light pulses generated at the plasma generation region 25 can be measured. The EUV light pulse energy sensor 7 may output the values of the energy of the EUV light pulses to the EUV light generation controller 5.

The laser beam direction control unit 34 and the EUV light generation controller 5 may be provided outside the chamber 2. The laser beam direction control unit 34 may include high-reflecting mirrors 341 and 342, as well as holders 343 and 344. The high-reflecting mirrors 341 and 342 may be held by the holders 343 and 344, respectively. The high-reflecting mirrors 341 and 342 may conduct the pulse laser beam outputted by the laser apparatus 3 to the laser beam focusing optical system 22a via the window 21.

The EUV light generation controller 5 may receive a control signal from the exposure apparatus 6. The EUV light generation controller 5 may control the target supply device 26 and the laser apparatus 3 in accordance with the control signal from the exposure apparatus 6.

### 4.2 Operation

FIG. 3 is a block diagram illustrating control of the target supply device 26 and the laser apparatus 3 performed by the EUV light generation controller 5. The EUV light generation controller 5 may include a target supply controller 51 and a laser controller 55. The target supply controller 51 may control operations performed by the target supply device 26. The laser controller 55 may control operations performed by the laser apparatus 3.

In addition to the reservoir 61 that holds the target material in a melted state, the target supply device 26 may include the heater 261, a temperature sensor 262, a pressure adjuster 263, a piezoelectric element 264, and a nozzle 265.

The heater 261 and the temperature sensor 262 may be anchored to the reservoir 61. The piezoelectric element 264 may be anchored to the nozzle 265. As shown in FIG. 2, the nozzle 265 may have the nozzle opening 62 that outputs the target 27, which is liquid Sn, for example. The pressure adjuster 263 may be provided in a pipe located between a not-shown inert gas supply section and the reservoir 61 to adjust the pressure of the inert gas supplied from the inert gas supply section into the reservoir 61.

The target supply controller 51 may control the heater 261 based on a value detected by the temperature sensor 262. For example, the target supply controller 51 may control the heater 261 so that the Sn within the reservoir 61 reaches a predetermined temperature greater than or equal to the melting point of the Sn. As a result, the reservoir 61 can melt the Sn held therewithin. The melting point of Sn is 232° C.; the predetermined temperature may be a temperature of 250° C. to 300° C., for example.

The target supply controller 51 may control a pressure within the reservoir 61 using the pressure adjuster 263. The pressure adjuster 263 may adjust the pressure within the reservoir 61 under the control of the target supply controller 51 so that the targets 27 reach the plasma generation region 25 at a predetermined velocity. The target supply controller 51 may send an electrical signal having a predetermined frequency to the piezoelectric element 264. The piezoelectric element 264 can vibrate in response to the received electrical signal, and can cause the nozzle 265 to vibrate at the stated frequency.

As a result, the droplet-shaped targets 27 can be generated from a jet of the liquid Sn outputted from the nozzle opening 62 as a result of the piezoelectric element 264 causing the nozzle opening 62 to vibrate. This method for generating targets is sometimes referred to as the “continuous jet method”. In this manner, the target supply device 26 can supply the droplet-shaped targets 27 to the plasma generation region 25 at a predetermined velocity and a predetermined interval. For example, the target supply device 26 may generate droplets at a predetermined frequency within a range of 50 kHz to 100 kHz.

When a target 27 passes through the focal position of light produced by the light-emitting section 45, the target sensor 4 may detect a change in the light passing through the trajectory of the target 27 and the vicinity thereof, and output a passage timing signal PT as a detection signal of the target 27. A detection pulse of the passage timing signal PT may be outputted to the laser controller 55 each time one target 27 is detected.

The EUV light pulse energy sensor 7 may measure the energy of an EUV light pulse in the plasma generation region 25 and output the value to the laser controller 55.

The laser controller 55 may receive a burst signal BT and a target value for the EUV light pulse energy from the exposure apparatus 6 via the EUV light generation controller 5. The EUV light generation controller 5 may control the laser apparatus 3 using the laser controller 55 such that the value measured by the EUV light pulse energy sensor 7 gets closer to the target value received from the exposure apparatus 6.

The burst signal BT may be a signal for instructing the EUV light generation system 11 to generate EUV light within a specified period. The laser controller 55 may perform control to output EUV light to the exposure apparatus 6 during the specified period.

Specifically, the laser controller 55 may control the laser apparatus 3 to output laser beam pulses in accordance with the passage timing signal PT in the period when the burst signal BT is ON. The laser controller 55 may control the laser apparatus 3 not to output laser beam pulses in the period when the burst signal BT is OFF.

For example, the laser controller 55 may output the burst signal BT received from the exposure apparatus 6 and a light emission trigger signal ET delayed by a predetermined time from the passage timing signal PT to the laser apparatus 3. When the burst signal is ON, the laser apparatus 3 may output laser beam pulses in response to light emission trigger pulses of the light emission trigger signal ET.

When the burst signal BT from the exposure apparatus 6 is OFF, the laser apparatus 3 may not output a pulse laser beam even when the laser apparatus 3 receives light emission trigger pulses of the light emission trigger signal ET. As a result, EUV light may not be generated.

The EUV light pulse energy sensor 7 may measure the pulse energy of EUV light and output an EUV light pulse energy signal EE indicating the measured pulse energy in the EUV light. The laser controller 55 may calculate a target value for the energy of a laser beam pulse to be outputted from the laser apparatus 3 based on a measured EUV light pulse energy and the target value received from the exposure apparatus 6 and send a feedback signal to the laser apparatus 3.

As described above, a series of EUV light pulses that continue for a specified period may be generated in accordance with the burst signal BT from the exposure apparatus 6. This series of EUV light pulses are also referred to as burst EUV light pulses. Likewise, a series of laser beam pulses that continue for a specified period in accordance with the burst signal BT are also referred to as burst laser beam pulses.

### 5. COMPARATIVE EXAMPLE OF CONFIGURATION OF LASER SYSTEM INCLUDING LASER APPARATUS AND LASER CONTROLLER

### 5.1 Configuration

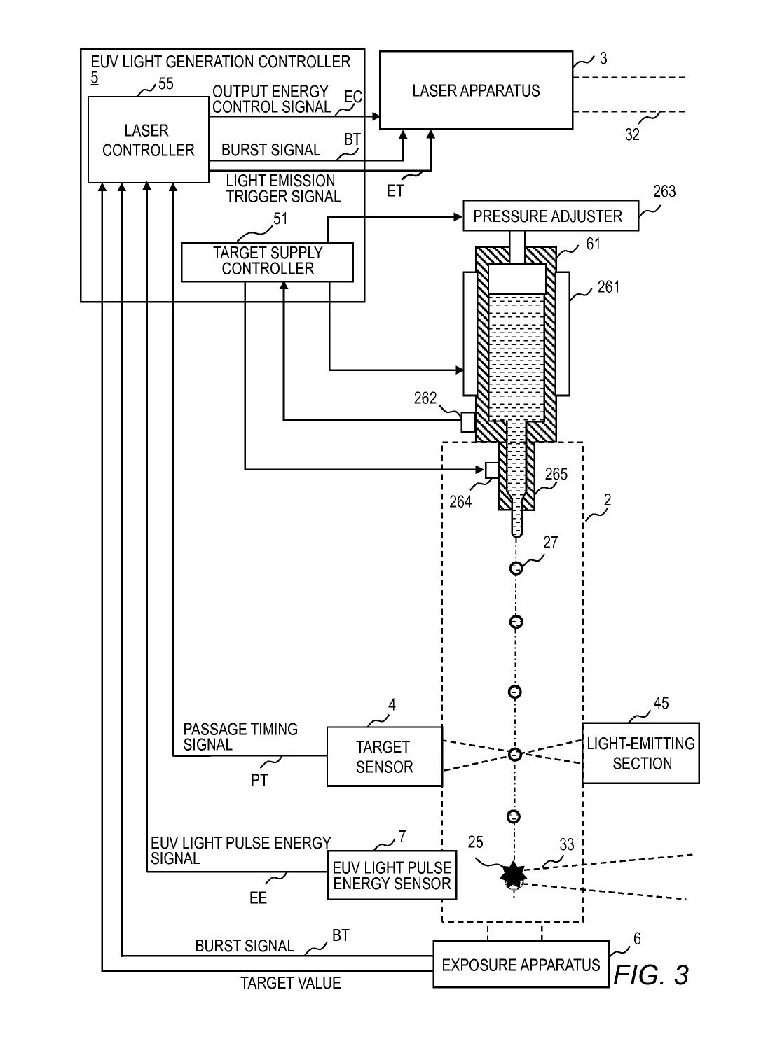

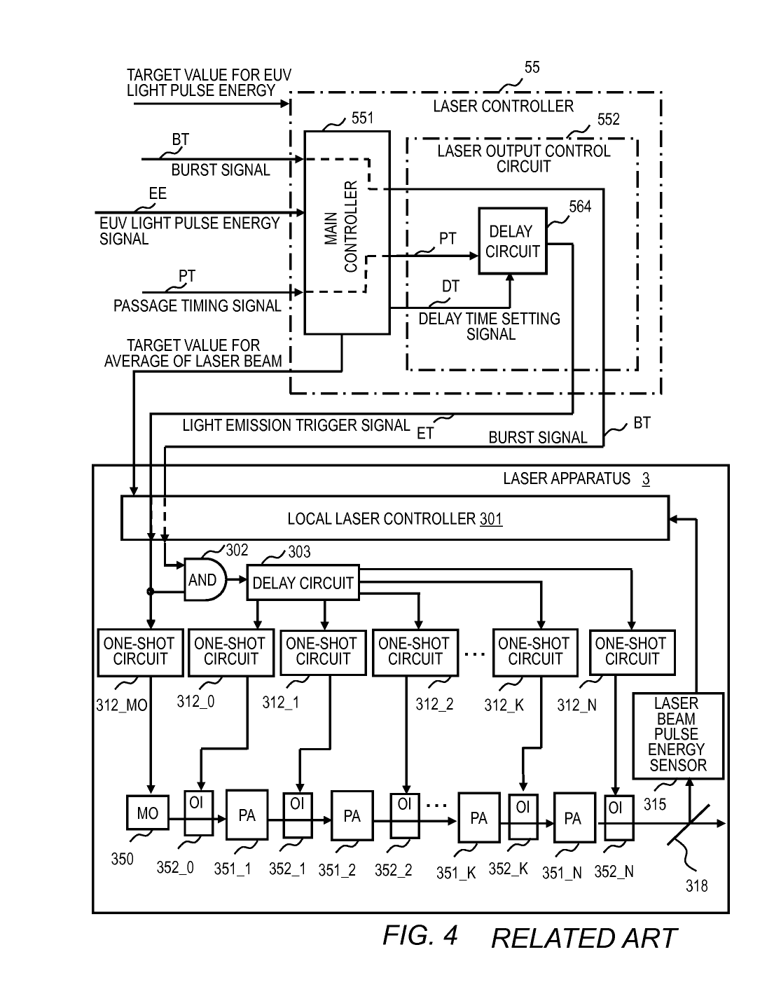

FIG. 4 schematically illustrates a comparative example of the configuration of a laser system including a laser apparatus 3 and a laser controller 55. The laser controller 55 may include a main controller 551 and a laser output control circuit 552.

The main controller 551 may receive a burst signal BT from the exposure apparatus 6 and output the bust signal BT to the laser output control circuit 552. The main controller 551 may receive a passage timing signal PT from the target sensor 4 and output the passage timing signal PT to the laser output control circuit 552.

The main controller 551 may receive an EUV light pulse energy signal EE from the EUV light pulse energy sensor 7 and determine a target value for the average of the laser beam pulse energy from the values indicated by the EUV light pulse energy signal EE. The main controller 551 may send the target value to the laser apparatus 3.

The laser output control circuit 552 may generate a light emission trigger signal ET from the passage timing signal PT received from the main controller 551. The laser output control circuit 552 may output the light emission trigger signal ET to the laser apparatus 3. The laser output control circuit 552 may output the burst signal BT received from the exposure apparatus 6 via the main controller 551 to the laser apparatus 3.

The laser output control circuit 552 may include a delay circuit 564. An input of the delay circuit 564 may be connected with the main controller 551 and an output of the delay circuit 564 may be connected with the laser apparatus 3. The main controller 551 may set a delay time td to the delay circuit 564 with a delay time setting signal DT. The delay circuit 564 may receive the passage timing signal PT, generate a light emission trigger signal ET delayed from the passage timing signal PT by the delay time td, and output the light emission trigger signal ET to the laser apparatus 3.

The laser apparatus 3 may include an local laser controller 301, an AND circuit 302, a delay circuit 303, one-shot circuits 312_MO and 312_0 to 312_N, and a laser beam pulse energy sensor 315. The laser apparatus 3 may further include a master oscillator (MO) 350, optical amplifiers (PA) 351_1 to 351_N, optical isolators (01) 352_0 to 352_N, and a beam splitter 318.

The master oscillator 350 may be a CO2 laser oscillator including a Q switch or a quantum-cascade laser (QCL) that oscillates in the amplification wavelength range of CO2 laser gas. The pulse laser beam outputted from the master oscillator 350 may be a linearly-polarized beam.

The optical amplifiers 351_1 to 351_N may be disposed in series on the optical path of the pulse laser beam outputted from the master oscillator 350 and sequentially amplify the pulse laser beam outputted from the master oscillator 350. The optical amplifiers 351_1 to 351_N may be the first-stage to the Nth-stage optical amplifiers. The number of stages for the optical amplifiers may be different depending on the design.

Each of the optical amplifiers 351_1 to 351_N may be a discharge-pumped amplifier including CO2 laser gas. Each of the optical amplifiers 351_1 to 351_N may include CO2 laser gas, a pair of electrodes, and a power supply for inducing high-frequency discharge between the pair of electrodes. If the master oscillator 350 is a device for outputting a small power (in tens of milliwatts) like a QCL, the first-stage optical amplifier 351_1 may be a regenerative amplifier including an optical resonator, an EO (Electro-Optic) Pockels cell and a polarizer.

The optical isolators 352_0 to 352_N may be disposed between the master oscillator 350 and the optical amplifier 351-1, between two adjacent optical amplifiers, and downstream of the optical amplifier 351_N on the optical path, respectively.

A part of the optical isolators 352_0 to 352_N may be omitted. For example, all the optical isolators at the downstream of the optical amplifier 351_K (K is any of 1 to N) may be omitted if the optical amplifiers are not resistant to laser beam. At least one optical isolator may be disposed at an upstream location where the pulse energy is low, for example, at least one of the places of between the master oscillator 350 and the optical amplifier 351_1, between the optical amplifiers 351_1 and 351_2, and between the optical amplifier 351_2 and 351_3.

The beam splitter 318 may be disposed downstream of the downmost optical isolator 352_N on the optical path. The beam splitter 318 may transmit part of a pulse laser beam and reflect part of the pulse laser beam to the laser beam pulse energy sensor 315.

The laser beam pulse energy sensor 315 may measure the laser beam pulse energy of the laser beam received from the beam splitter 318. The laser beam pulse energy sensor 315 may send the measured laser beam pulse energy values to the local laser controller 301.

The local laser controller 301 may control other components in the laser apparatus 3. The local laser controller 301 may receive the light emission trigger signal ET, the burst signal BT and the target value for the average of the laser beam pulse energy from the laser controller 55.

The local laser controller 301 may calculate the average of the laser beam pulse energy from the detected values by the laser beam pulse energy sensor 315 and control the excitation intensities of the optical amplifiers 351_1 to 351_N such that the average gets closer to the target value. For example, the local laser controller 301 may control the voltage applied to the electrodes of each optical amplifier to control the excitation intensity.

The local laser controller 301 may output the light emission trigger signal ET and the burst signal BT to the AND circuit 302. The local laser controller 301 may output the light emission trigger signal ET to the one-shot circuit 312_MO.

Two inputs of the AND circuit 302 may be connected with two outputs from the local laser controller 301. One input may receive the light emission trigger signal ET and the other input may receive the burst signal BT. The AND circuit 302 may output an ON signal when both of the light emission trigger signal ET and the burst signal BT are ON and output an OFF signal when at least either one of the signals is OFF. In the present disclosure, the ON signal may be a high level and the OFF signal may be a low level.

The input of the delay circuit 303 may be connected with the output of the AND circuit 302. The delay circuit 303 may generate signals different in delay time from the signal received from the AND circuit 302 and output the signals to the one-shot circuits 312_0 to 312_N, respectively. The delay times of the output signals may increase in the order from the delay time for the one-shot circuit 312_0 to the delay time for the one-shot circuit 312_N.

An input of the one-shot circuit 312_MO may be connected with an output of the local laser controller 301 and receive the light emission trigger signal ET. Inputs of the one-shot circuits 312_0 to 312_N may be connected with outputs of the delay circuit 303 and receive signals different in delay time.

Outputs of the one-shot circuits 312_MO and 312_0 to 312_N may be correspondingly connected with inputs of the master oscillator 350 and the optical isolator 352_0 to 352_N. The one-shot circuits 312_MO and 312_0 to 312_N may output pulse signals having a predetermined pulse width in response to edges of the input signals.

### 5.2 Operation

The main controller 551 may output a delay time setting signal DT to the delay circuit 564 to set a specific delay time td. The delay time td may be set such that the pulse laser beam is focused on the plasma generation region 25 when a target 27 detected by the target sensor 4 reaches the plasma generation region 25.

The delay time td may be given by the following formula, for example:

td=L/v−α,

where L may represent the distance from the target detection position 40 to the center of the plasma generation region 25, v may represent the velocity of the target 27, and α may represent the time required after a light emission trigger pulse for instructing the laser apparatus 3 to emit a pulse laser beam is outputted until the pulse laser beam is focused on the plasma generation region 25.

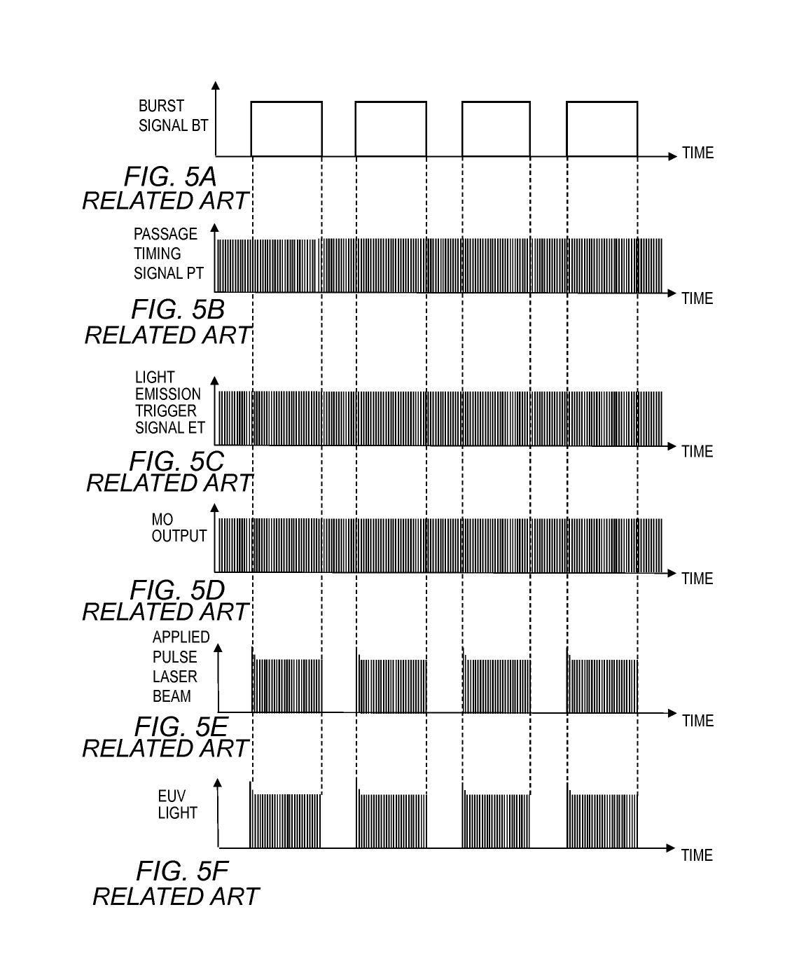

Hereinafter, an example of operations of the laser apparatus 3 under the control of the laser controller 55 is described with reference to FIGS. 5A to 5F. FIGS. 5A to 5F are timing charts of the control signals from the laser controller 55 to the laser apparatus 3, the pulse laser beam, and the EUV light.

FIGS. 5A to 5F respectively show temporal variations of the burst signal BT, the passage timing signal PT, the light emission trigger signal ET, the output of the master oscillator 350, the pulse laser beam applied to the plasma generation region 25, and the EUV light.

The local laser controller 301 may control the optical amplifiers 351_1 to 351_N in accordance with instructions from the main controller 551 such that the excitation intensities of the optical amplifiers 351_1 to 351_N become predetermined values. Specifically, the local laser controller 301 may control a not-shown power supply to induce a high-frequency discharge in each of the optical amplifiers 351_1 to 351_N to pump CO2 laser gas, which may enable the excitation intensities of the optical amplifiers 351_1 to 351_N to be the predetermined values.

The main controller 551 may output the burst signal BT received from the exposure apparatus 6 to the local laser controller 301. As shown in FIG. 5A, the burst signal BT may have an ON period and an OFF period. In the period when the burst signal BT is ON, the pulse laser beam may be outputted to the plasma generation region 25. In the period when the burst signal BT is OFF, the pulse laser beam may not be outputted to the plasma generation region 25.

The main controller 551 may output the passage timing signal PT received from the target sensor 4 to the delay circuit 564. As shown in FIG. 5B, the passage timing signal PT may include a pulse indicating detection of a target 27. The delay circuit 564 may delay the passage timing signal PT by a delay time td to generate a light emission trigger signal ET and output the light emission trigger signal ET to the local laser controller 301. As shown in FIG. 5C, the light emission trigger signal ET may include light emission trigger pulses generated by delaying the pulses in the passage timing signal PT.

The light emission trigger signal ET may be inputted to the AND circuit 302 and the one-shot circuit 312_MO through local laser controller 301. The one-shot circuit 312_MO may output a pulse having a predetermined width to the master oscillator 350 in response to an edge of the light emission trigger signal ET. As shown in FIG. 5D, the master oscillator 350 may output a pulse laser beam synchronously with the pulses from the one-shot circuit 312_MO.

The burst signal BT may be inputted to the AND circuit 302 through the local laser controller 301. The output of the AND circuit 302 may be ON when both of the light emission trigger signal ET and the burst signal BT are ON and may be OFF when at least either one is OFF. That is to say, the AND circuit 302 may output a light emission trigger signal ET to the delay circuit 303 only when the burst signal BT is ON.

Pulses outputted from the delay circuit 303 when the burst signal BT is ON may be inputted to the one-shot circuits 312_0 to 312_N with different delay times, respectively. The delay times can increase in the order from the delay time for the one-shot circuit 312_0 to the delay time for the one-shot circuit 312_N. The one-shot circuits 312_0 to 312_N may sequentially output pulses having predetermined widths to the optical isolators 352_0 to 352_N in response to edges of the input signals.

The pulses outputted from the delay circuit 303 may be delayed from the light emission trigger pulse inputted to the one-shot circuit 312_MO. Accordingly, the output pulses from the one-shot circuit 312_MO and the one-shot circuits 312_0 to 312-N may be gradually delayed to be outputted to the master oscillator 350 and the optical isolators 352_0 to 352_N in this order.

The optical isolators 352_0 to 352_N may have an open state and a closed state. The optical isolators 352_0 to 352_N may be in the open state when the input signals from the one-shot circuits 312_0 to 312_N are ON and in the closed state when the input signals from the one-shot circuits 312_0 to 312_N are OFF.

The delay circuit 303 may output signals to the one-shot circuits 312_0 to 312_N such that a laser beam pulse from the master oscillator 350 will pass through the optical isolators 352_0 to 352_N.

The optical isolators 352_0 to 352_N may change from the closed state to the open state in time for passage of a laser beam pulse in accordance with the pulses from the one-shot circuit 312_0 to 312_N and let the laser beam pulse pass through. The optical isolators 352_0 to 352_N may change to a closed state after the passage of the laser beam pulse and maintain the closed state just before the passage of the next laser beam pulse.

The optical isolators 352_0 to 352_N may change to the open state only when the optical isolators 352_0 to 352_N let a laser beam pulse pass therethrough. This configuration may prevent unstable operations of the master oscillator 350 and the optical amplifier 351_1 to 351_N and self-oscillation of the optical amplifiers 351_1 to 351_N caused by input of reflection light from a target 27 to the master oscillator 350 and the optical amplifiers 351_1 to 351_N.

When the burst signal BT is OFF, the optical isolators 352_0 to 352_N may maintain the closed state. In this state, as shown in FIG. 5E, the pulse laser beam outputted from the master oscillator 350 may be prevented from being amplified by the optical amplifiers 351_1 to 351_N, so that pulse laser beam may not be outputted from the laser apparatus 3.

When the burst signal BT is ON, the optical isolators 352_0 to 352_N can change to an open state. In this state, the pulse laser beam outputted from the master oscillator 350 may be successively amplified by the optical amplifiers 351_1 to 351_N and applied to the plasma generation region 25 as shown in FIG. 5E.

The pulse laser beam outputted from the laser apparatus 3 may pass through the laser beam direction control unit 34, the window 21, and the laser beam focusing optical system 22a, and strike at a target 27 that has reached the plasma generation region 25. As a result, the target 27 may be turned into plasma to generate EUV light.

Regarding the first and subsequent several consecutive laser beam pulses after the burst signal BT has changed from OFF to ON, the laser beam pulse energy may tend to gradually decrease but to be high compared to the laser beam pulse energy of the following pulses as shown in FIG. 5E. Regarding the burst EUV light pulses, the EUV light pulse energy in the first and subsequent several pulses of a burst may tend to gradually decrease but to be high compared to the EUV light pulse energy of the following pulses as shown in FIG. 5F, like the applied pulse laser beam.

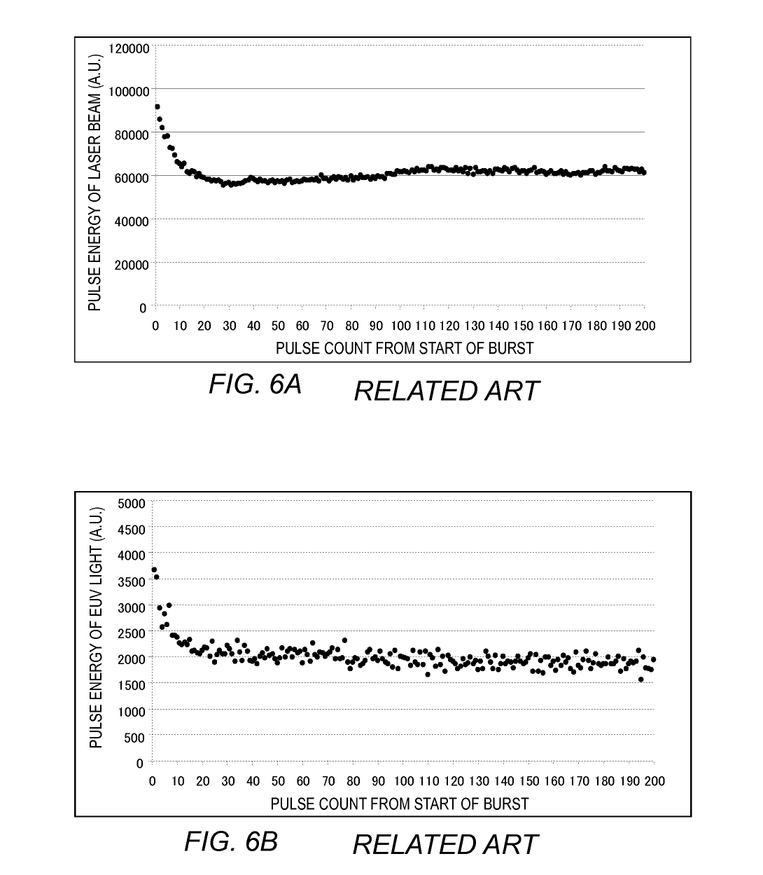

FIGS. 6A and 6B show an example of measured pulse energy of burst laser beam pulses and an example of measured pulse energy of burst EUV light pulses, respectively. In FIG. 6A, the horizontal axis represents pulses counted from the first pulse in the burst laser beam pulses and the vertical axis represents the laser beam pulse energy. In FIG. 6B, the horizontal axis represents pulses counted from the first pulse in the burst EUV light pulses and the vertical axis represents the EUV light pulse energy. In FIG. 6A, the cyclic frequency of the laser beam pulse is 100 kHz and the cycle is 10 μs.

The pulse energy of the pulse laser beam and the pulse energy of the EUV light are both very unstable from the first pulse to about the 20th pulse in the burst pulses. Specifically, the pulse energy gradually decreases from the first pulse to about the 20th pulse; the variation in energy in the pulses is greater than the variation in energy in the subsequent pulses.

### 5.3 Issues

### 5.3.1 Stabilizing EUV Light Pulse Energy

The EUV light generation apparatus 1 may be required to output stable EUV light pulses having the target energy to the exposure apparatus 6 for appropriate exposure. As described above, the EUV light pulse energy may vary pulse by pulse. Accordingly, it may be important that the EUV light generation apparatus 1 controls the pulse energy at every EUV light pulse.

Furthermore, the pulse energy may be very unstable in a few tens of pulses from the first pulse in a series of burst EUV light pulses. Control to stabilize the energy for the first and subsequent few tens of pulses in a burst may be important.

To stabilize the pulse energy of the EUV light at a target value, it may be necessary that the EUV light generation apparatus 1 controls the pulse energy of the pulse laser beam from the laser apparatus 3 speedily and precisely. For example, the cyclic frequency of the pulse laser beam may be approximately 100 kHz, that is, the cycle of the pulse laser beam may be approximately 10 μs. Accordingly, for the pulse laser beam energy control, a response time within a half of the cycle of 10 μs may be required.

Controlling the excitation intensity of an optical amplifier may not achieve controlling the pulse energy in a response time within a half of the cycle of 10 μs. An optical isolator may be used for pulse laser beam energy control since the optical isolator may change the transmittance of light. However, it may be difficult for the optical isolator to control the energy of a pulse laser beam with high precision. Hereinafter, this issue is described.

### 5.3.2. Configuration of Optical Isolator

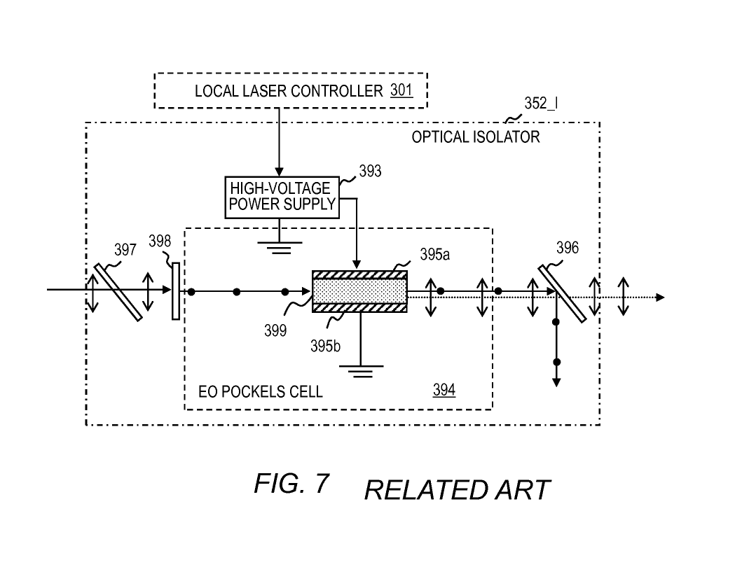

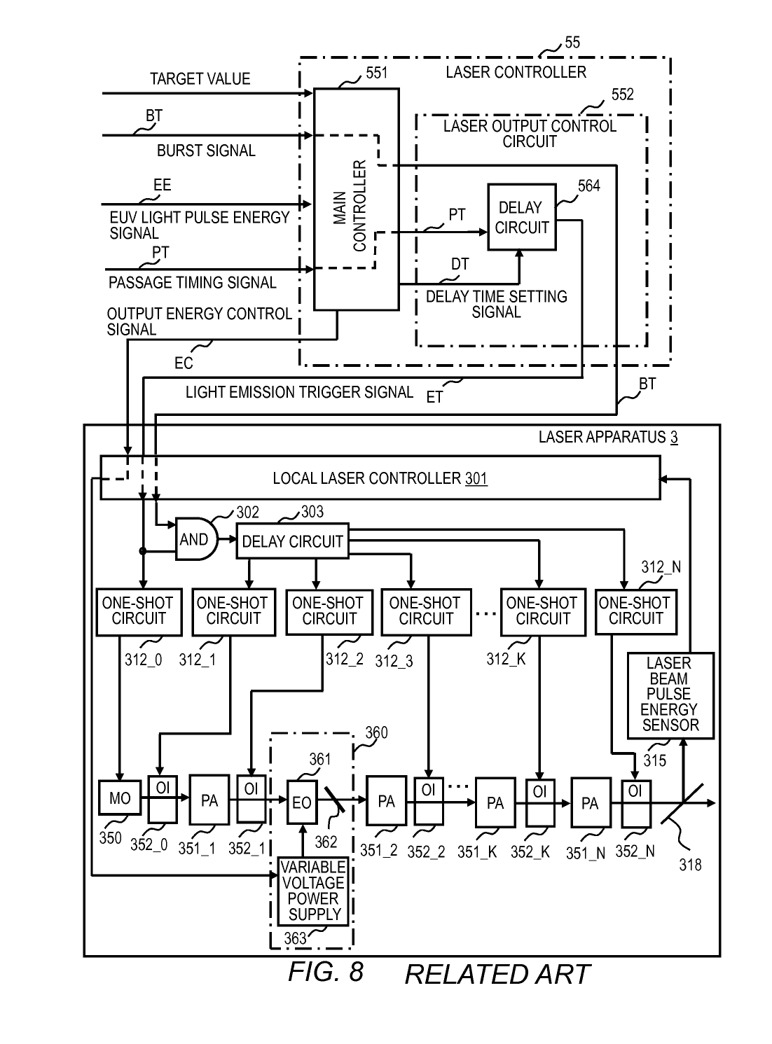

A configuration example of an optical isolator 352_1 (1 is any of 0 to N) is described. FIG. 7 schematically illustrates a configuration example of the optical isolator 352_1. The optical isolator 352_1 may include a high-voltage power supply 393, an EO Pockels cell 394, a first polarizer 396, a second polarizer 397, and a λ/2 plate 398. The EO Pockels cell 394 may include a pair of electrodes 395a and 395b opposed to each other across an electro-optic crystal 399.

The second polarizer 397 and the λ/2 plate 398 may be disposed on the optical path on the input side of the EO Pockels cell 394. The first polarizer 396 may be disposed on the optical path on the output side of the EO Pockels cell 394.

The high-voltage power supply 393 may output a control voltage for the EO Pockels cell 394. The high-voltage power supply 393 may receive a pulse signal from the one-shot circuit 312_1 included in the laser apparatus 3.

When the pulse signal is ON, the high-voltage power supply 393 may generate a predetermined voltage other than 0 V and apply the voltage between the pair of electrodes 395a and 395b of the EO Pockels cell 394. When the pulse signal is OFF, the high-voltage power supply 393 may apply a voltage of approximately 0 V between the pair of electrodes 395a and 395b of the EO Pockels cell 394.

The pulse laser beam outputted from the optical amplifier 351_1 of the laser apparatus 3 may be a light beam linearly polarized in a direction parallel to the plane of the sheet. The second polarizer 397 may transmit the pulse laser beam, which is light linearly polarized in a direction parallel to the plane of the sheet, at high transmittance and reflect light linearly polarized in a direction perpendicular to the plane of the sheet into a direction different from the incident optical path. The λ/2 plate 398 may rotate the polarization direction of the pulse laser beam by 90 degrees to transmit the pulse laser beam. That is to say, the pulse laser beam outputted from the λ/2 plate 398 may be a beam linearly polarized in a direction perpendicular to the plane of the sheet.

When a predetermined high voltage is applied between the pair of electrodes 395a and 395b, the EO Pockels cell 394 may change the phase difference between orthogonal polarization components of the pulse laser beam by 180 degrees to transmit the pulse laser beam. That is to say, the EO Pockels cell 394 may modulate the polarization direction of the pulse laser beam by 90 degrees to transmit the pulse laser beam. When no voltage is applied between the pair of electrodes 395a and 395b, the EO Pockels cell 394 may transmit the pulse laser beam without changing the phase difference between orthogonal polarization components of the pulse laser beam. That is to say, the EO Pockels cell 394 may transmit the pulse laser beam without changing the polarizing direction.

The first polarizer 396 may transmit light of a pulse laser beam linearly polarized in a direction parallel to the plane of the sheet and reflect light linearly polarized in a direction perpendicular to the plane of the sheet into a direction different from the optical path of the pulse laser beam.

That is to say, the first polarizer 396 may transmit a pulse laser beam modulated by the EO Pockels cell 394 when the pulse signal from the one-shot circuit 312_1 is ON. The first polarizer 396 may reflect a pulse laser beam unmodulated by the EO Pockels cell 394 into a direction different from the incident optical path when the pulse signal from the one-shot circuit 312_1 is OFF.

As described above, the optical isolator 352_1 may exhibit functionality of an optical isolator by well transmitting light from the upstream and the downstream when a high voltage is applied to the EO Pockels cell 394 and restraining the transmission of light from both of the upstream and the downstream when the high voltage is not applied to the EO Pockels cell 394 and the applied voltage to the EO Pockels cell 394 is approximately 0 V.

The high-voltage power supply 393 may apply pulses of high voltage to the pair of electrodes 395a and 395b by rapidly turning on and off a charging switch connected with the high voltage and a discharge switch connected to ground.

### 5.3.3 Issue on Control of Laser Beam Pulses by Optical Isolator

The optical isolator 352_1 may control the transmittance at every laser beam pulse by changing the voltage applied from the high-voltage power supply 393 to the EO Pockels cell 394.

However, the optical isolator 352_1 may be required to maintain a closed state before and after passage of a laser beam pulse to block the reflection from the target 27. For the optical isolator 352_1 to change the transmitted energy of the laser beam pulse at every pulse, it may be necessary to change the voltage applied to the EO Pockels cell 394 from 0 V to the target voltage with high precision and high speed at every laser beam pulse. It may be difficult for a common high-voltage power supply 393 to control the output voltage with such high precision and high speed.

### 6. LASER SYSTEM INCLUDING LASER APPARATUS INCLUDING VARIABLE ATTENUATOR AND LASER CONTROLLER

The laser apparatus 3 in the present embodiment may include a variable attenuator on the optical path of the pulse laser beam, in addition to optical isolators. The variable attenuator may continuously change the energy of the laser beam pulses passing therethrough. Using the variable attenuator in addition to the optical isolators for switching blocking and transmitting light may enable the energy of the pulse laser beam outputted from the laser apparatus 3 to be appropriately controlled at each pulse.

### 6.1 Configuration

FIG. 8 schematically illustrates a configuration example of the laser system including the laser apparatus 3 including a variable attenuator and a laser controller 55 for controlling the laser apparatus 3. Hereinafter, differences from the comparative example in FIG. 4 are mainly described.

The laser apparatus 3 may include a variable attenuator 360 provided on the optical path between the optical isolator 352_1 and the optical amplifier 351_2. The variable attenuator 360 may include an EO Pockels cell 361, a polarizer 362, and a variable voltage power supply 363.

The main controller 551 of the laser controller 55 may output an output energy control signal EC to the local laser controller 301. The local laser controller 301 may output the output energy control signal EC received from the main controller 551 to the variable attenuator 360.

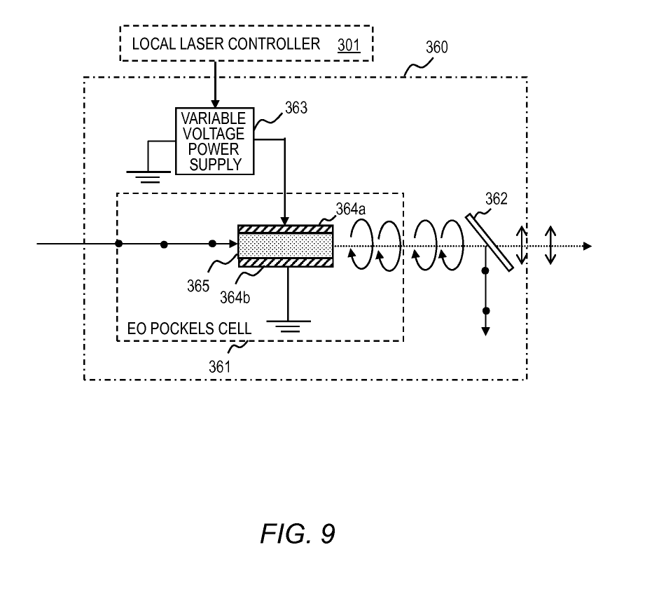

FIG. 9 schematically illustrates a configuration of the variable attenuator 360. The EO Pockels cell 361 may include a pair of electrodes 364a and 364b opposed to each other across an electro-optic crystal 365.

The variable voltage power supply 363 may apply voltage V at a value ranging from 0 to Vmax between the pair of electrodes 364a and 364b. The EO Pockels cell 361 may continuously change the phase difference between orthogonal polarization components of the pulse laser beam by 0 to λ/2 in accordance with the voltage V (0 to Vmax) applied to the pair of electrodes 364a and 364b.

When no voltage (V=0) is applied to the electro-optic crystal 365, the pulse laser beam linearly polarized in a direction perpendicular to the plane of the sheet may pass through the electro-optic crystal 365 while maintaining the polarized state. The transmitted beam can be reflected by the polarizer 362.

When a specific voltage V (0<V<Vmax) is applied to the electro-optic crystal 365, the pulse laser beam linearly polarized in a direction perpendicular to the plane of the sheet may be converted into an elliptically polarized beam by the EO Pockels cell 361. The polarization component parallel to the plane of the sheet may pass through the polarizer 362 and the polarization component perpendicular to the plane of the sheet may be reflected by the polarizer 362.

When the highest voltage (V=Vmax) is applied, the phase may be shifted by λ/2 and the beam linearly polarized in a direction perpendicular to the plane of the sheet may be converted into a beam linearly polarized in a direction parallel to the plane of the sheet. The beam linearly polarized in a direction parallel to the plane of the sheet may pass through the polarizer 362. The transmittance of the polarizer 362 may increase with increase in voltage V and reach the highest transmittance when the voltage is Vmax.

As described above, the variable attenuator 360 may control the voltage applied to the electro-optic crystal 365 by controlling the variable voltage power supply 363. The variable attenuator 360 may change the polarization state of the pulse laser beam to change the transmittance of the polarizer 362 for the pulse laser beam traveling therethrough by controlling the voltage V. As a result, the variable attenuator 360 may change the energy of the pulse laser beam passing therethrough with high speed and high precision.

### 6.2 Operation

Operations of the laser system including the laser apparatus including the variable attenuator 360 and a laser controller are described basically based on FIG. 8. The main controller 551 of the laser controller 55 may receive a target value for the energy of EUV light from the exposure apparatus 6. The target value may be EUV light pulse energy Pext or the number of pulses S for moving summation.

The main controller 551 may receive a detected value P of the EUV light pulse energy sensor 7 with the EUV light pulse energy signal EE. The main controller 551 may determine a voltage V for the variable voltage power supply 363 of the variable attenuator 360 to apply to the EO Pockels cell 361 based on the detected value P and the target value. The main controller 551 may send the determined voltage V to the variable attenuator 360 with the output energy control signal EC. The variable voltage power supply 363 can apply voltage at the value V received from the main controller 551 to the EO Pockels cell 361.

The master oscillator 350 can output a linearly-polarized pulse laser beam in response to input of an emission trigger pulse while the bust signal BT is ON. The pulse laser beam can pass through the optical isolator 352_0 and be amplified by the optical amplifier 351_1. The amplified linearly-polarized pulse laser beam can pass through the optical isolator 352_1 and enter the variable attenuator 360.

The incident pulse laser beam may be a beam linearly polarized in a direction perpendicular to the plane of the sheet. The EO Pockels cell 361 may change the phase difference between the orthogonal polarization components of the pulse laser beam in accordance with the voltage applied between the pair of electrodes 364a and 364b. The pulse laser beam incident on the variable attenuator 360 may change in polarization state in accordance with the voltage applied to the EO Pockels cell 361.

For example, the pulse laser beam may change from a linearly-polarized beam into an elliptically-polarized beam. When the elliptically-polarized beam enters the polarizer 362, the polarization component perpendicular to the plane of the sheet may be reflected and the polarization component parallel to the plane of the sheet may pass through. As a result, the pulse laser beam transmitted through the polarizer 362 may be an attenuated linearly-polarized beam.

The attenuated linearly-polarized pulse laser beam may be amplified by the optical amplifier 351_2, pass through the optical isolator 352_2, and alternately pass through optical amplifiers and optical isolators to be amplified sequentially. The pulse laser beam amplified by the last optical amplifier 351_N may pass through the optical isolator 352_N and enter the beam splitter 318.

The beam splitter 318 may partially reflect the incident beam to the laser beam pulse energy sensor 315. The laser beam pulse energy sensor 315 may measure the pulse energy of the pulse laser beam being outputted from the laser apparatus 3 and send the measurement data to the local laser controller 301.

The pulse laser beam outputted from the laser apparatus 3 may pass through the laser beam direction control unit 34, the window 21, and the laser beam focusing optical system 22a, and strike at a target 27 that has reached the plasma generation region 25. As a result, the target 27 may turned into plasma to generate EUV light.

The EUV light pulse energy sensor 7 may measure the pulse energy of the EUV light. The EUV light pulse energy sensor 7 may send measurement data of the pulse energy of the EUV light to the laser controller 55 by an EUV light pulse energy signal EE.

The laser controller 55 may determine the voltage V to be applied to the EO Pockels cell 361 based on the target value received from the exposure apparatus 6 and the measured pulse energy P of the EUV light such that the value obtained from the measured pulse energy P of the EUV light gets closer to the target value. The laser controller 55 may send the determined value to the laser apparatus 3 in an output energy control signal EC.

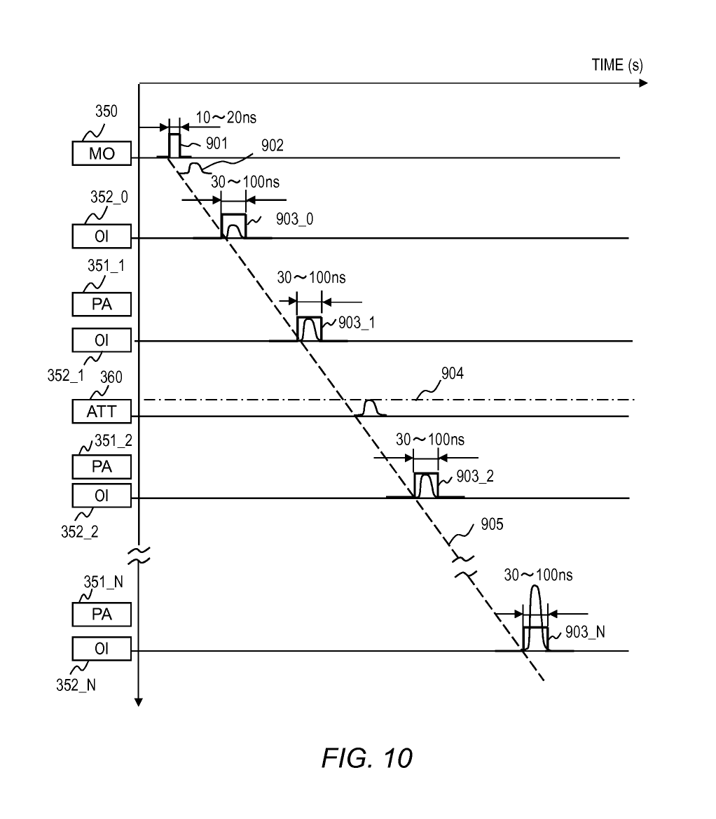

FIG. 10 schematically illustrates the operation timing of the optical isolators 352_0 to 352_N. For example, the optical path length from the master oscillator 350 to the optical isolator 352_N in the laser apparatus 3 may be 50 m to 200 m.

As shown in FIG. 10, the master oscillator 350 may activate a Q switch synchronously with an inputted light emission trigger pulse 901 to output a predetermined width of laser beam pulse 902. The predetermined width may be, for example, 10 ns to 20 ns.

The laser beam pulse 902 outputted from the master oscillator 350 may travel along the optical path at the velocity of light (3×10⁸ m/s).

Immediately before the passage of the laser beam pulse 902 through the optical isolators 352_0 to 352_N, voltages 903_0 to 903_N at predetermined values may be applied to the corresponding optical isolators 352_0 to 352_N. The EO Pockels cells in the optical isolators 352_0 to 352_N may shift the phase difference in the laser beam pulse 902 by λ/2 at the predetermined voltage values.

The voltages 903_0 to 903_N applied to the optical isolators 352_0 to 352_N may be changed to approximately 0 V immediately after the passage of the laser beam pulse 902. As noted, the voltages 903_0 to 903_N may be applied like a pulse and the width thereof may be, for example, 30 ns to 100 ns.

The variable attenuator 360 may attenuate the energy of the laser beam pulse 902 in accordance with the applied voltage 904. The voltage 904 applied to the EO Pockels cell 361 of the variable attenuator 360 may not need to change like a pulse with passage of a laser beam pulse. In the time range shown in FIG. 10, the voltage 904 applied to the EO Pockels cell 361 may be maintained at a substantially fixed value corresponding to the desired transmittance of the EO Pockels cell 361.

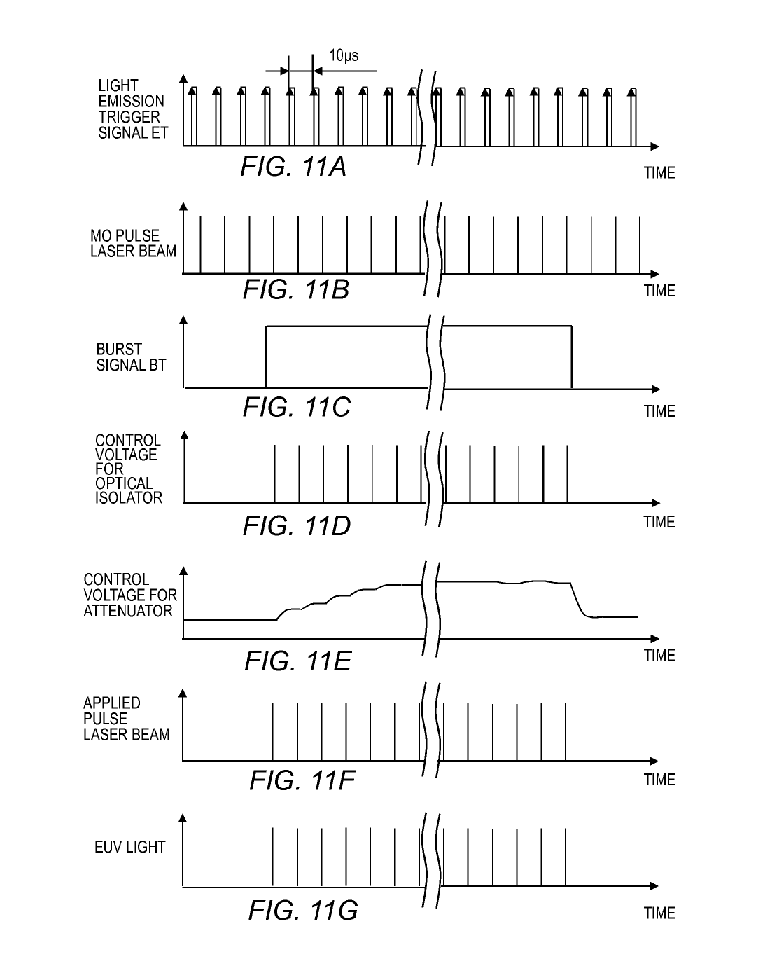

FIGS. 11A to 11G are timing charts of control signals in the laser apparatus 3, a pulse laser beam, and EUV light. FIGS. 11A to 11E respectively show temporal variations of the light emission trigger signal ET, the output of the master oscillator 350, the burst signal BT, the control voltage for one optical isolator, and the control voltage for the attenuator. FIGS. 11F and 11G respectively show temporal variations of the pulse laser beam applied to the plasma generation region 25 and the EUV light.

As shown in FIGS. 11A and 11B, the master oscillator 350 may output laser beam pulses synchronously with light emission trigger pulses. The cycle of a light emission trigger pulse may be, for example, 10 μs.

As shown in FIG. 11C, the burst signal BT may be ON for a specific period. This specific period is also referred to as burst period hereinafter. As shown in FIG. 11D, a control voltage pulsing with the laser beam pulses may applied to the optical isolator 352_1 during the burst period.

As to the variable attenuator 360, the variable voltage power supply 363 may apply control voltage that may vary step by step with the laser beam pulses to the EO Pockels cell 361 during the burst period as shown in FIG. 11E. The variable attenuator 360 may change the control voltage to the EO Pockels cell 361 from a value used for a previous laser beam pulse to a value for the current laser beam pulse.

Since the optical isolators 352_0 to 352_N may block reflection, the variable attenuator 360 may not need to change to a closed state. Accordingly, the control voltage for the variable attenuator 360 may vary step by step, unlike the pulsing control voltage for the optical isolators 352_0 to 352_N. The control voltage for the variable attenuator 360 may vary within a small range between two laser beam pulses and may be maintained at the same value for a long time. Accordingly, the variable voltage power supply 363 may control the applied voltage for the EO Pockels cell 361 with high precision.

In particular, the EO Pockels cell 361 may exhibit the transmittance highly dependent on the applied voltage in the range of 10% to 90%, compared to the other rates. The control of applied voltage to the variable attenuator 360 in the present embodiment may control the transmittance of the EO Pockels cell 361 having such a feature with high precision.

### 6.3 Effects

The present embodiment may control the transmittance of each laser beam pulse at the speed corresponding to the cyclic frequency of the pulse laser beam by controlling the voltage applied to the EO Pockels cell 361 of the variable attenuator 360. The energy of individual laser beam pulses may change by traveling through the variable attenuator 360. As a result, the energy of the laser beam pulses amplified by the subsequent stages of optical amplifiers 351_2 to 351_N may be changed, as well as the EUV light pulses generated by the laser beam pulses.

### 6.4 Others

In the example of FIG. 8, the variable attenuator 360 is disposed on the optical path between the optical isolator 352_1 and the optical amplifier 351_2. The variable attenuator 360 may be disposed at a different place as far as the variable attenuator 360 is disposed on the optical path of the pulse laser beam between the master oscillator 350 and the plasma generation region 25.

Preferably, the variable attenuator 360 may be disposed on the optical path between the master oscillator 350 and the optical amplifier 351_3 where the energy of the pulse laser beam is low. More preferably, the variable attenuator 360 may be disposed on the optical path between the optical amplifier 351_1 and the optical isolator 352_1 or between the optical isolator 352_1 and the optical amplifier 351_2. The laser apparatus 3 may include a plurality of variable attenuators.

### 7. CONTROL OF APPLIED VOLTAGE IN VARIABLE ATTENUATOR 360

### 7.1 First Control Method

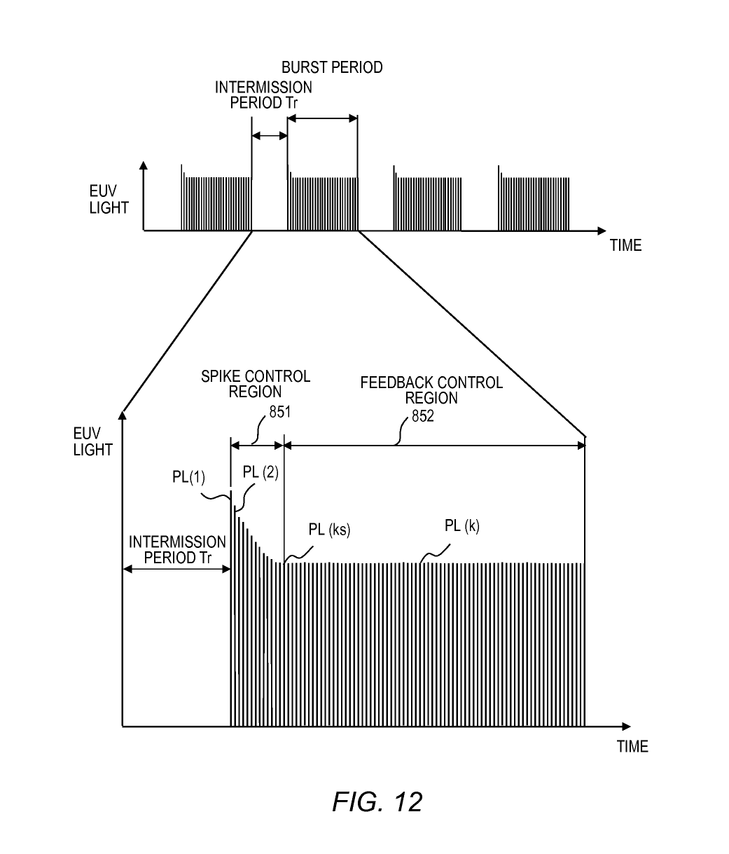

Hereinafter, an example of controlling the applied voltage in the variable attenuator 360 by the laser controller 55 is described. FIG. 12 schematically illustrates temporal variation of pulse energy of burst EUV light pulses. The laser controller 55 may separate a series of burst EUV light pulses into a spike control region 851 and a feedback control region 852 to control the pulse energy of EUV light.

In the following description, PL(m) represents the m-th pulse from the beginning of one control cycle. In FIG. 12, the spike control region 851 may include pulses from the first EUV light pulse PL(1) to the EUV light pulse PL(ks), where ks may be an integer greater than 1, for example 20. The feedback control region 852 may include all of the EUV light pulses subsequent to the spike control region 851.

The variation of pulse energy of the EUV light in the first and subsequent several pulses may depend on the intermission period Tr, which is a period when the burst is OFF. The intermission period Tr may be a period after the last pulse of the previous burst EUV pulses until the first pulse of the current burst EUV pulses. In the control of the laser apparatus 3, the intermission period Tr may be represented by the period between the end time of the previous burst period and the start time of the current burst period.

The laser controller 55 may perform control differently for the spike control region 851 and the feedback control region 852. In the spike control region 851, the laser controller 55 may control the applied voltage V to the EO Pockels cell 361 of the variable attenuator 360 based on the latest intermission period Tr and the past control result for a pulse of the same pulse number in the burst as the pulse to be controlled. In the feedback control region 852, the laser controller 55 may control the applied voltage V to the EO Pockels cell 361 of the variable attenuator 360 based on the control result of the latest EUV light pulse.

### (Outline of Control Method)

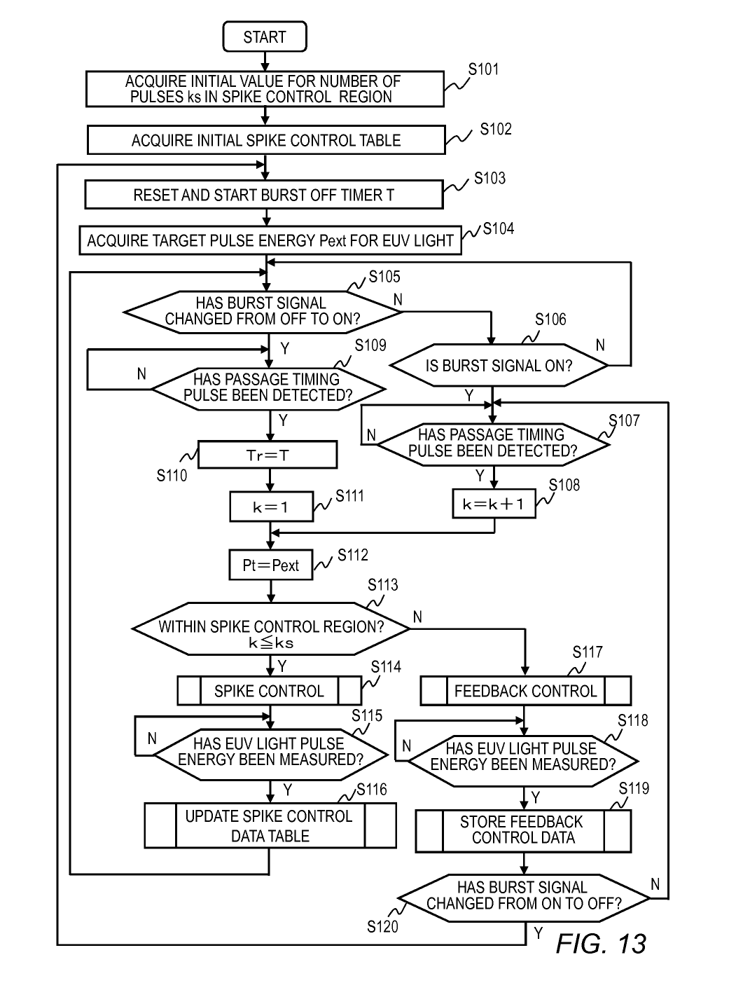

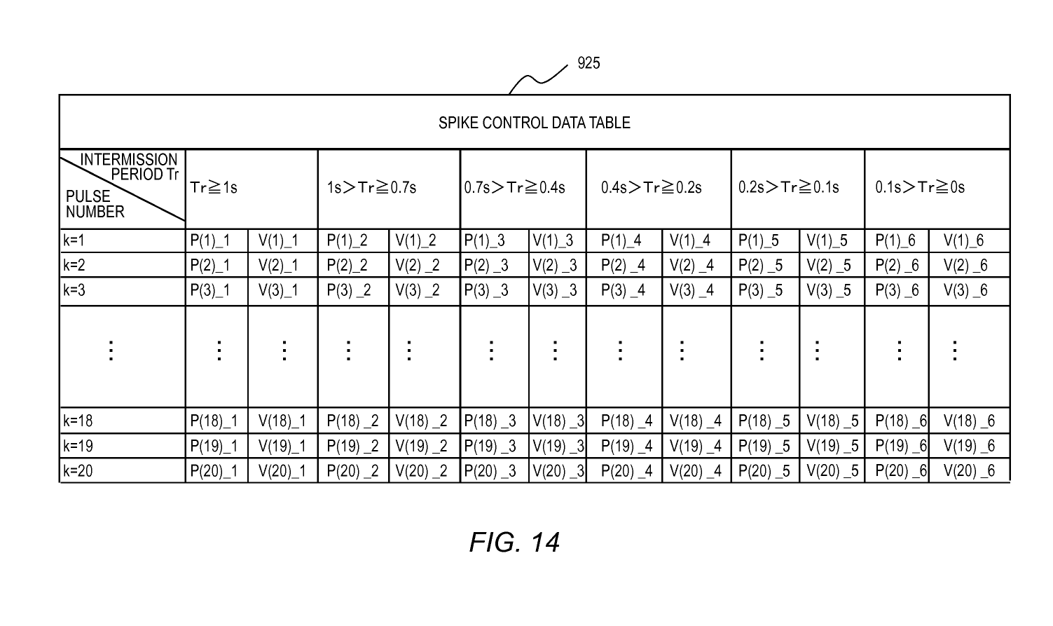

FIG. 13 is an example of a flowchart of controlling the applied voltage in the variable attenuator 360. This control method may control the applied voltage in the variable attenuator 360 such that the measured EUV light pulse energy value gets closer to the target EUV light pulse energy Pext received as a target value from the exposure apparatus 6.

In FIG. 13, the laser controller 55 may acquire the initial value (for example, 20) for the number of pulses ks in a spike control region 851 (S101). Next, the laser controller 55 may acquire a spike control data table having an initial configuration (S102). The laser controller 55 may hold the initial value for the number of pulses ks and the spike control data table having an initial configuration in a not-shown storage such as a non-volatile storage device. The details of the spike control data table will be described later.

The laser controller 55 may reset and start a burst OFF timer (S103). The burst OFF timer can measure an intermission period Tr. The laser controller 55 may acquire the target EUV light pulse energy Pext for the EUV light (S104). The laser controller 55 may receive the target EUV light pulse energy Pext from the exposure apparatus 6 and hold it in advance.

The laser controller 55 may monitor the burst signal BT from the exposure apparatus 6 to determine whether the burst signal BT has changed from OFF to ON (S105). If the burst signal BT has not changed from OFF to ON (S105: N), the laser controller 55 may determine whether the burst signal BT is ON (S106).

If the burst signal BT is OFF (S106: N), the laser controller 55 may return to Step S105. If the burst signal BT is ON (S106: Y), the laser controller 55 may monitor the passage timing signal PT (S107: N). Upon detection of a passage timing pulse indicating passage of a target 27 (S107: Y), the laser controller 55 may change the value of a variable k into k+1 (S108). The variable k may represent the pulse number of the pulse to be controlled counted from the beginning of the burst. Thereafter, the laser controller 55 may proceed to Step S112.

At Step S105, if the laser controller 55 determines that the burst signal BT has changed from OFF to ON (S105: Y), the laser controller 55 may monitor the passage timing signal PT (S109: N). Upon detection of a passage timing pulse indicating passage of a target 27 (S109: Y), the laser controller 55 may substitute the value of the burst OFF timer for a variable Tr (S110). The variable Tr may represent an intermission period for the current burst EUV light pulses to be controlled. Next, the laser controller 55 may substitute 1 for the variable k (S111) and proceed to Step S112.

At Step S112, the laser controller 55 may substitute the target EUV light pulse energy Pext for a variable Pt. The variable Pt may represent the pulse energy of the EUV light pulse to be controlled. Next, the laser controller 55 may compare the variable k with the number of pulses ks in the spike control region 851 to determine whether the current EUV light pulse is a pulse included in the spike control region 851 (S113).

If the pulse to be controlled is a pulse in the spike control region 851 (S113: Y), the laser controller 55 may determine the voltage value to be applied to the variable attenuator 360 with spike control (S114). The details of the spike control will be described later. The laser controller 55 may monitor whether the EUV light pulse energy has been measured (S115: N).

Upon receipt of a measured EUV light pulse energy value from the EUV light pulse energy sensor 7 (S115: Y), the laser controller 55 may update the spike control data table (S116). The details of the spike control data table and updating the spike control data table will be described later.

At Step S113, if the pulse to be controlled is not a pulse in the spike control region 851 (S113: N), that is, if the pulse to be controlled is a pulse in the feedback control region 852, the laser controller 55 may determine the voltage value to be applied to the variable attenuator 360 with feedback control (S117). The details of the feedback control will be described later. The laser controller 55 may monitor whether the EUV light pulse energy has been measured (S118: N).

Upon receipt of a measured EUV light pulse energy value from the EUV light pulse energy sensor 7 (S118: Y), the laser controller 55 may store the feedback control data in a not-shown storage such as a memory (S119). The details of the feedback control will be described later.

After Step S119, the laser controller 55 may monitor whether the burst signal BT has changed from ON to OFF (S120). If the burst signal BT is still ON (S120: N), the laser controller 55 may return to Step S107 and wait for the next passage timing pulse.

If the burst signal BT has changed to OFF (S120: Y), the laser controller 55 may return to Step S105 and wait for the next burst period since this series of burst EUV light pulses has ended.

### (Spike Control Data Table)

FIG. 14 illustrates a configuration example of the spike control data table 925. The spike control data table 925 may store the history of control results in the spike control region 851. The spike control may determine the voltage V to be applied in the variable attenuator 360 using the data in the spike control data table 925.

The spike control data table 925 may indicate the relation between the pulse energy P(k) and the applied voltage V(k) in the variable attenuator 360 in each EUV light pulse in the spike control region 851. In the example of FIG. 14, the spike control region 851 includes 20 EUV light pulses.

In the spike control data table 925, the intermission period Tr may be grouped into a plurality of ranges. The spike control data table 925 may indicate the relation between the pulse energy P(k) and the applied voltage V(k) in each of the plurality of ranges. In the example of FIG. 14, the intermission period Tr is divided into six ranges; P(k)_m and V(k)_m respectively represent the pulse energy and the applied voltage in the m-th range.

The laser controller 55 may hold in advance a spike control data table 925 including initial values in the storage. Upon start of the operations illustrated in the flowchart of FIG. 13, the laser controller 55 may execute spike control with the spike control data table 925 including the initial values (S114). Thereafter, the laser controller 55 may successively update the spike control data table 925 with the applied voltages V(k) and the pulse energy P(k) in the actual spike control (S116).

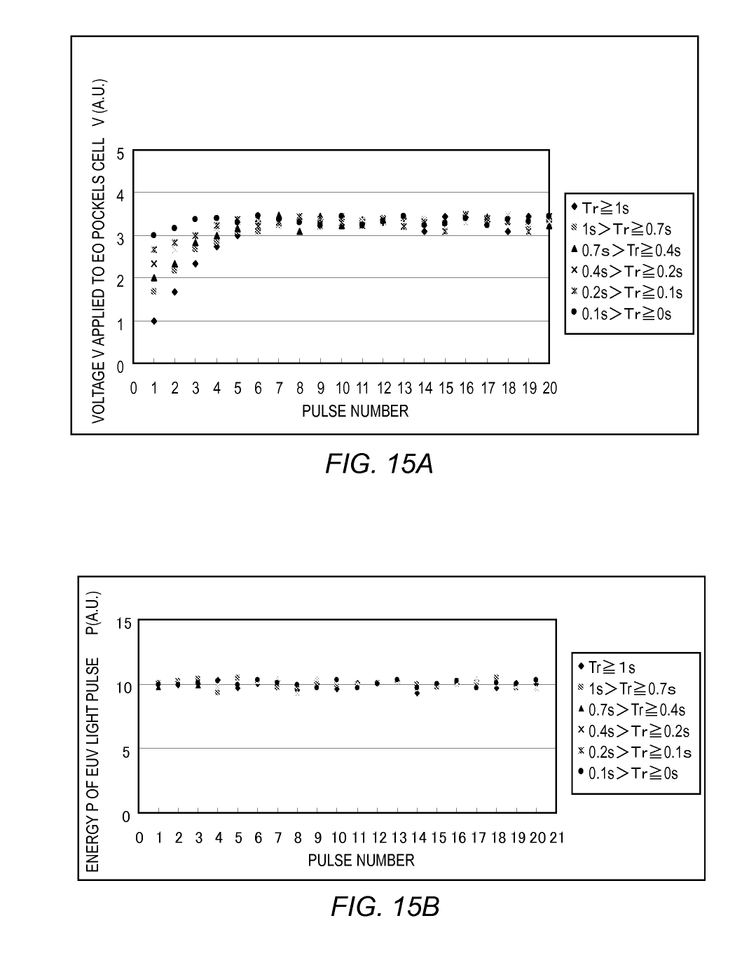

FIGS. 15A and 15B show examples of measured applied voltages in the variable attenuator 360 and measured EUV light pulse energy in spike control. FIGS. 15A and 15B show measurement results on burst EUV pulses following intermission periods Tr of different ranges.

FIG. 15A shows an example of measured voltages V(1) to V(20) applied to the EO Pockels cell 361 of the variable attenuator 360 in the spike control. The horizontal axis represents the pulse number in the burst EUV light pulses and the vertical axis represents the voltage V applied to the EO Pockels cell 361. FIG. 15B shows the measurement results of EUV light pulse energy P(1) to P(20) in the measurements concurrent with the measurements of FIG. 15A. The horizontal axis represents the pulse number in the burst EUV light pulses and the vertical axis represents the energy of the EUV light pulse.

The laser controller 55 may successively update the spike control data table 925 in accordance with the control results as shown in FIGS. 15A and 15B. Through measurements on burst EUV light pulses following different lengths of intermission periods Tr, the laser controller 55 may change all the values in the spike control data table 925 into actual control results.

### (Spike Control)

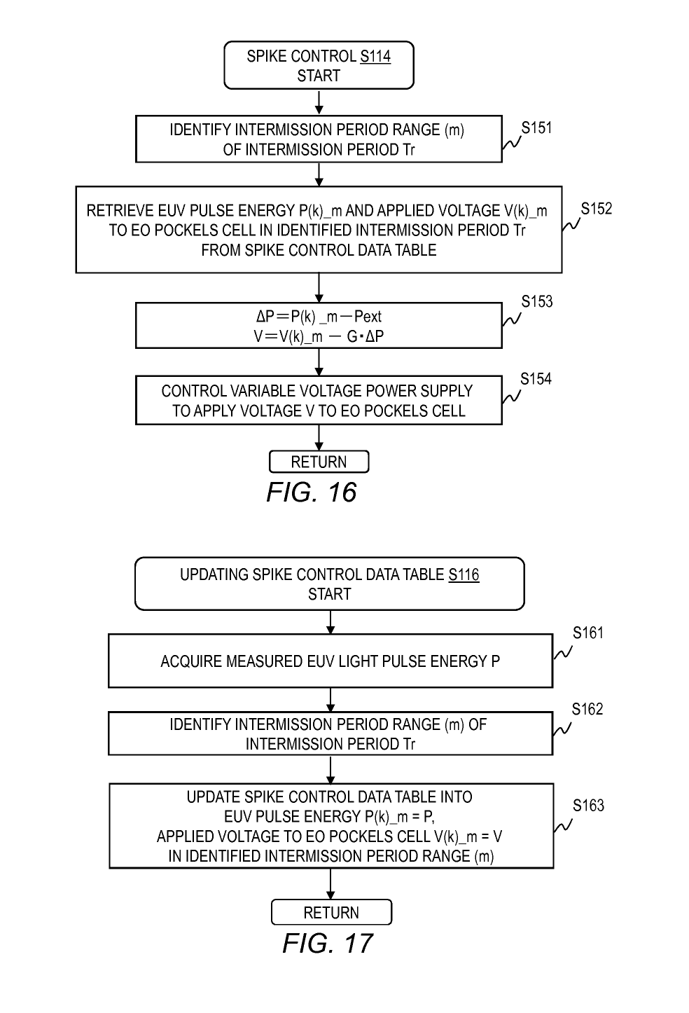

FIG. 16 is an example of a flowchart of the spike control S114 in the flowchart of FIG. 13. First, the laser controller 55 may identify the intermission period range (m) including the measured value T of the latest intermission period Tr preceding the current burst EUV light pulses (S151).

Next, the laser controller 55 may refer to the spike control data table 925 and acquire the EUV light pulse energy P(k)_m and the applied voltage V(k)_m to the EO Pockels cell 361 for the current pulse number (k) in the column of the identified intermission period range (m) (S152). The values of P(k)_m, V(k)_m may be the initial values or the latest measured values of P(k) and V(k) in the intermission period range (m).

The laser controller 55 may calculate the value for the voltage V to be applied to the EO Pockels cell 361 in accordance with the following formulae using the EUV light pulse energy P(k)_m and the applied voltage V(k)_m to the EO Pockels cell 361 acquired from the spike control data table 925 (S153):

ΔP=P(k)_m−Pext

V=V(k)_m−G·ΔP,

where Pext may represent the target value received from the exposure apparatus 6 and G may represent a constant. The laser controller 55 may send the calculated value for the voltage V to the local laser controller 301 with the output energy control signal EC. The laser controller 55 may control the variable voltage power supply 363 with the local laser controller 301 to apply the calculated voltage V to the EO Pockels cell 361 (S154).

### (Updating Spike Control Data Table)

FIG. 17 is an example of a flowchart of updating the spike control data table S116 in the flowchart of FIG. 13. First, the laser controller 55 may acquire the measured EUV light pulse energy value P from the EUV light pulse energy sensor 7 (S161). The laser controller 55 may identify the intermission period range (m) including the measured value T of the latest intermission period Tr preceding the current burst EUV light pulses (S162).

The laser controller 55 may update the values of P(k)_m and V(k)_m in the column of the identified intermission period range (m) of the spike control data table 925 with the measured EUV light pulse energy value P and the voltage V applied to the EO Pockels cell 361 in the current control (S163).

### (Feedback Control)

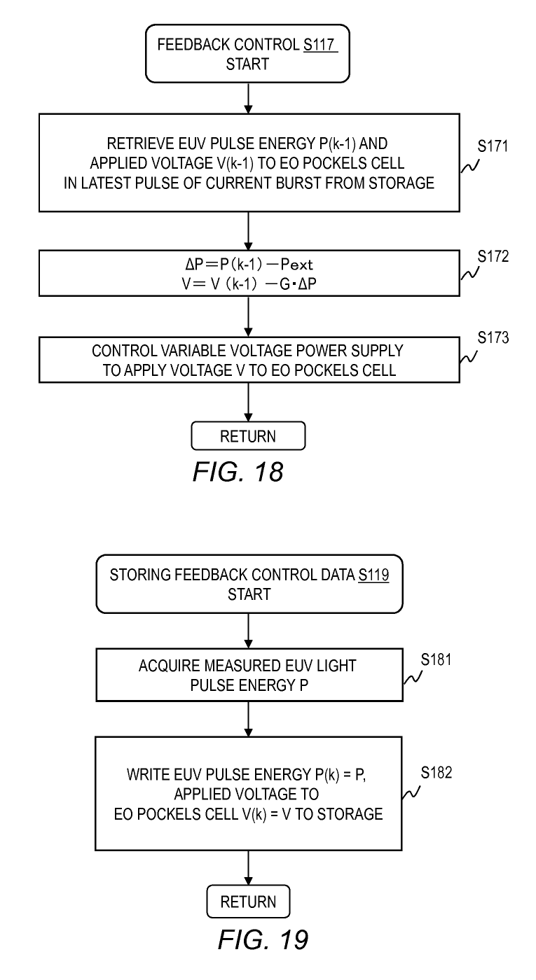

FIG. 18 is an example of a flowchart of the feedback control S117 in the flowchart of FIG. 13. The laser controller 55 may acquire the EUV light pulse energy P(k−1) and the applied voltage V(k−1) to the EO Pockels cell 361 in the latest pulse of the burst EUV light pulses from the storage (S171).

The laser controller 55 may calculate the value for the voltage V to be applied to the EO Pockels cell 361 in accordance with the following formulae using the acquired values (S172):

ΔP=P(k−1)−Pext

V=V(k−1)−G·ΔP,

where Pext may represent the target value received from the exposure apparatus 6 and G may represent a constant. The laser controller 55 may send the calculated value for the voltage V to the local laser controller 301 with the output energy control signal EC. The laser controller 55 may control the variable voltage power supply 363 with the local laser controller 301 to apply the calculated voltage V to the EO Pockels cell 361 (S173).

### (Storing Feedback Control Data)

FIG. 19 is an example of a flowchart of storing the feedback control data S119 in the flowchart of FIG. 13. First, the laser controller 55 may acquire the measured EUV light pulse energy value P from the EUV light pulse energy sensor 7 (S181). Next, the laser controller 55 may write the measured EUV light pulse energy value P and the voltage V applied to the EO Pockels cell 361 in the current control to the storage as P(k) and V(k) (S182).

### (Effects)

The above-described control may stabilize the energy of the EUV light pulses to enter the exposure apparatus 6 by performing spike control or feedback control on each laser beam pulse such that the energy of the EUV light pulses gets closer to the target EUV light pulse energy Pext specified by the exposure apparatus 6.

The above-described spike control may control the variable attenuator 360 appropriately for the spike control region 851 where the variation of laser beam pulse energy is large by controlling the transmittance of the variable attenuator 360 using the past control results.

The above-described spike control may control the variable attenuator 360 in the spike control region 851 appropriately for the intermission period Tr by dividing the intermission period Tr into a plurality of ranges to manage the pulse energy P(k) and the applied voltage V(k).

The above-described feedback control may control the variable attenuator 360 appropriately for the feedback control region 852 where the variation of laser beam pulse energy is small by controlling the transmittance of the variable attenuator 360 using the past control results within the same burst EUV light pulses.

### 7.2 Second Control Method

Hereinafter, the second method for the laser controller 55 to control the applied voltage in the variable attenuator 360 is described. In the following, differences from the above-described first control method are mainly described. Between the second control method and the first control method, the spike controls may be different and the feedback controls may be the same. The second control method may determine the target EUV light pulse energy using the moving summation of the measured EUV light pulse energy values. The moving summation may be a summation of the latest n values (n is an integer more than 1).

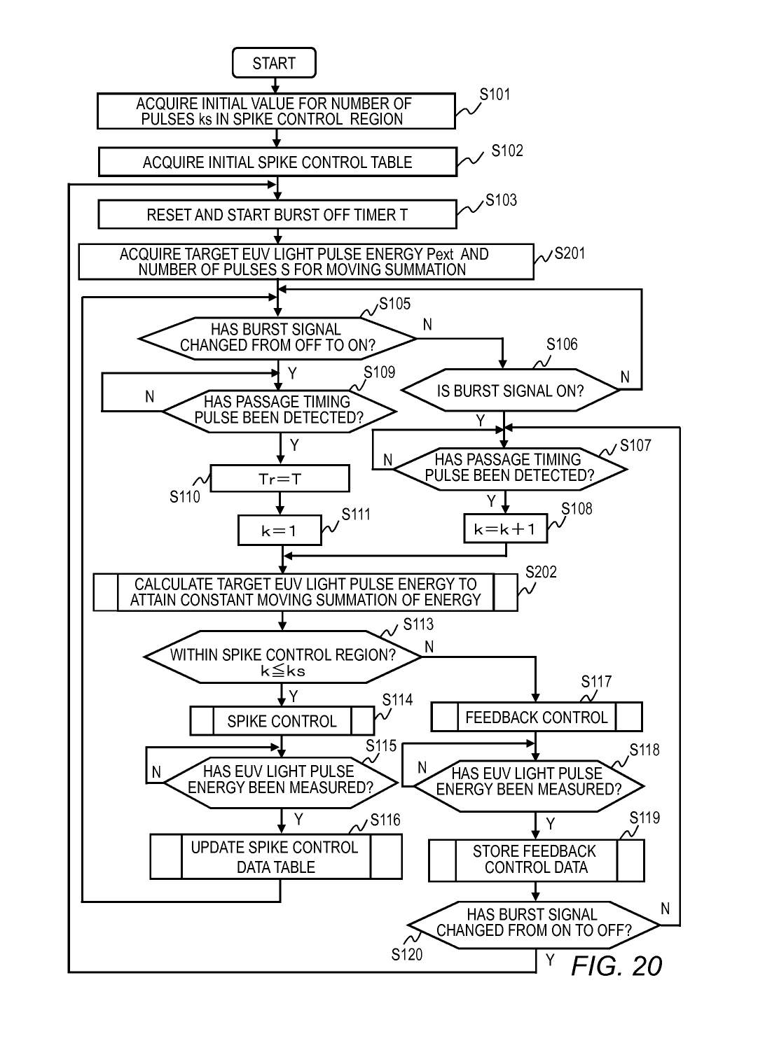

FIG. 20 is a flowchart of an example of controlling the applied voltage in the variable attenuator 360. Hereinafter, differences from the flowchart of FIG. 13 are described. After execution of Step S103, the laser controller 55 may acquire the target EUV light pulse energy Pext and further, may acquire the number of pulses S for moving summation (S201).

The laser controller 55 may receive the target EUV light pulse energy Pext from the exposure apparatus 6 and hold it in advance. The number of pulses S for moving summation may be stored in the storage such as a non-volatile storage device of the laser controller 55 in advance. Subsequent to Step S108 or S111, the laser controller 55 may calculate the target EUV light pulse energy to attain a constant moving summation of energy (S202). The other steps are the same as those in the flowchart of FIG. 13.

### (Calculation of Target EUV Light Pulse Energy)

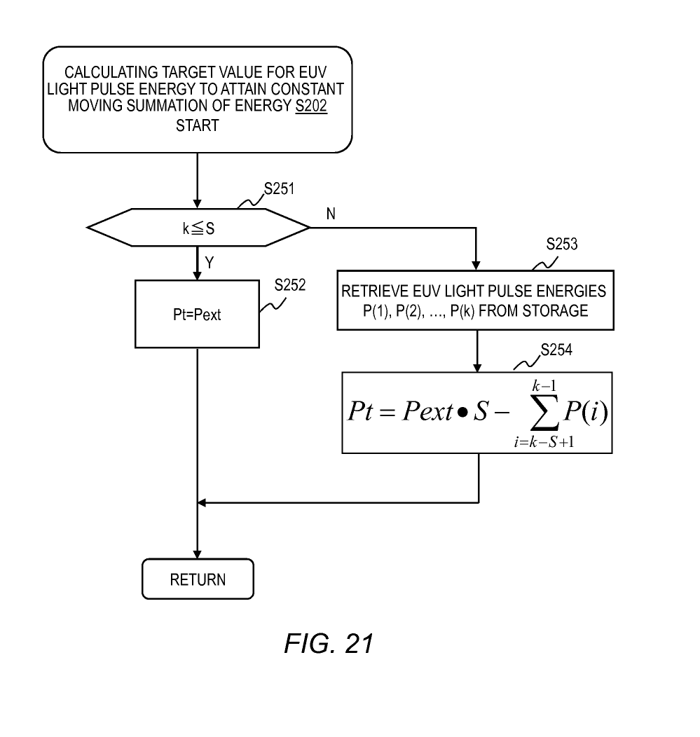

FIG. 21 is an example of a flowchart of Step S202 in the flowchart of FIG. 20. The laser controller 55 may determine whether the current EUV light pulse number k counted from the first EUV light pulse is greater than the number of pulses S for moving summation (S251). If the pulse number k is not greater than the value of the number of pulses S for moving summation (S251: Y), the laser controller 55 may determine the target EUV light pulse energy Pt for the current EUV light pulse to be Pext (S252).

If the pulse number k is greater than the value of the number of pulses S for moving summation (S251: N), the laser controller 55 may retrieve the EUV light pulse energy values P(1), P(2), . . . , and P(k) from the storage (S253). The laser controller 55 may calculate the target EUV light pulse energy Pt such that the moving summation becomes a fixed value (Pext·S) (S254). The fixed value Pext·S may represent the target value of the moving summation of the EUV light pulse energy inclusive of the EUV light pulse energy of the current pulse. The laser controller 55 may calculate the target EUV light pulse energy Pt in accordance with the following formula, for example:

$$Pt = Pext \cdot S - {\sum }_{i = k - S + 1}^{k - 1} P ( i )$$

The foregoing formula may represent the difference between Pext·S and the sum of the pulse energy values of previous (S−1) consecutive EUV light pulses from the last pulse.

### (Effects)

The above-described spike control may make the summation of the pulse energy values actually applied to the exposed wafer closer to the target value by determining the target value of the EUV light pulse energy of the current pulse using the moving summation of measured EUV light pulse energy values and the target summation value.

As set forth above, the present invention has been described with reference to embodiments; the foregoing description is merely for the purpose of exemplification but not limitation. Accordingly, it is obvious for a person skilled in the art that the embodiments in this disclosure can be modified within the scope of the appended claims.

For example, the present invention is applicable to apparatuses other than an EUV light generation system. For example, the present invention is applicable to a laser processing apparatus. The laser apparatus can control the pulse energy of a pulse laser beam pulse by pulse in accordance with the present invention. The control method for a variable attenuator of the present invention is not limited to the above-described methods. The configurations of a variable attenuator and an optical isolator are not limited to the above-described configurations, either.

The above-described components and functions such as the laser controller 55 and the local laser controller 301, for all or a part of them, may be implemented by hardware: for example, by designing an electric circuit. The above-described components and functions may be implemented by software, which means that a processor interprets and executes programs for providing the functions.

A part of the configuration of an embodiment can be replaced with a configuration of another embodiment. A configuration of an embodiment can be incorporated to a configuration of another embodiment. A part of the configuration of each embodiment can be removed, added to a different configuration, or replaced by a different configuration.

The terms used in this specification and the appended claims should be interpreted as “non-limiting”. For example, the terms “include” and “be included” should be interpreted as “including the stated elements but not limited to the stated elements”. The term “have” should be interpreted as “having the stated elements but not limited to the stated elements”. Further, the modifier “one (a/an)” should be interpreted as “at least one” or “one or more.”

### REFERENCE SIGNS

2 Chamber, 3 Laser apparatus, 4 Target sensor, 5 EUV light generation controller, 6 Exposure apparatus, 7 EUV light pulse energy sensor, 11 EUV light generation system, 21 Window, 25 Plasma generation region, 26 Target supply device, 27 Target, 31, 32 and 33 Pulse laser beam, 34 Laser beam direction control unit, 51 target supply controller, 55 Laser controller, 301 Local laser controller, 302 AND circuit, 303 Delay circuit, 312_MO and 312_0 to 312_N One-shot circuits, 315 Laser beam pulse energy sensor, 318 Beam splitter, 350 Master oscillator, 351_1 to 351_N Optical amplifiers, 352_0 to 352_N Optical isolators, 360 Variable attenuator, 361 Pockels cell, 362 Polarizer, 363 Variable voltage power supply, 364a and 364b Electrodes, 365 Electro-optic crystal, 393 High-voltage power supply, 394 Pockels cell, 395a and 395b Electrodes, 396 and 397 Polarizers, 398 λ/2 plate, 399 Electro-optic crystal, 551 Main controller, 552 Laser output control circuit, 564 delay circuit, 851 Spike control region, 852 Feedback control region, 901 Light emission trigger pulse, 902 Laser beam pulse, 903_0 to 903_N Applied voltage, 904 Applied voltage, 925 Spike control data table

What is claimed is:

1. A laser system comprising:
a master oscillator configured to output laser beam pulses;
multiple stages of optical amplifiers disposed on an optical path of the laser beam pulses outputted from the master oscillator and configured to sequentially amplify the laser beam pulses;
an optical isolator disposed on the optical path and capable of switching between an open state and a closed state;
an optical attenuator disposed on the optical path and capable of setting an optical transmittance; and
a controller configured to control the optical isolator and the optical attenuator,
wherein the controller controls the optical isolator to switch from the closed state to the open state and then to return to the closed state for each of the laser beam pulses repeatedly outputted from the master oscillator, and
the controller controls the optical attenuator to set an optical transmittance of the optical attenuator for each of the laser beam pulses repeatedly outputted from the master oscillator.

2. An extreme ultraviolet light generation system comprising:
the laser system according to claim 1;
a chamber including a plasma generation region to be irradiated with laser beam pulses from the laser system;
a target supply device configured to successively supply a target to the plasma generation region in the chamber;
a target detection device configured to detect passage of a target outputted from the target supply device through a predetermined position between the target supply device and the plasma generation region; and
a sensor capable of measuring one of energy of the laser beam pulses and energy of extreme ultraviolet light pulses generated in the plasma generation region,
wherein the controller of the laser system controls the master oscillator and the optical isolator in accordance with a detection signal from the target detection device and determines an optical transmittance of the optical attenuator in accordance with a value measured by the sensor.

3. A control method for a laser apparatus including a master oscillator configured to output laser beam pulses, multiple stages of optical amplifiers disposed on an optical path of the laser beam pulses outputted from the master oscillator and configured to sequentially amplify the laser beam pulses, an optical isolator disposed on the optical path and capable of switching between an open state and a closed state, and an optical attenuator disposed on the optical path and capable of setting an optical transmittance, the control method comprising:
controlling the optical isolator to switch from the closed state to the open state and then to return to the closed state for each of the laser beam pulses repeatedly outputted from the master oscillator; and
controlling the optical attenuator to set an optical transmittance of the optical attenuator for each of the laser beam pulses repeatedly outputted from the master oscillator.
